(19) United States
(12) Patent Application Publication
(10) Pub. No.: US 2011/0320390 A1
(43) Pub. Date: Dec. 29, 2011

(54) METHOD FOR IDENTIFICATION, PREDICTION AND PROGNOSIS OF CANCER AGGRESSIVENESS

(76) Inventors: Vladimir A. Kuznetsov, Singapore (SG); Efthimios Motakis, Singapore (SG)

(21) Appl. No.: 13/255,900

(22) PCT Filed: Mar. 10, 2010
(86) PCT No.: PCT/SG10/00078

§ 371 Date: Sep. 9, 2011

(30) Foreign Application Priority Data
Mar. 10, 2009 (SG) 200901682-5

(51) Int. Cl. G06N 3/12

(52) U.S. Cl. 706/13

(57) ABSTRACT

A survival model, for each of one or more pairs of genes, includes a function of a corresponding measure of the ratio of expression levels of the pairs of genes. For each pair of genes, there is a corresponding a cut-off value, such that patients are classified according to whether the corresponding measure is above or below the cut-off value. It is proposed (in an algorithm called “DDgR”) that the cut-off value should be selected so as to maximise the separation of the respective survival curves of the two groups of patients. It is further proposed that, for each of a number of genes or gene pairs, a selection is made from multiple survival models. The selection is according to whether a proportionality assumption is obeyed and/or according to a measure of data fit, such as the Baysian Information Criterion (BIC). Specific gene pairs identified by the methods are named.

### RELATED APPLICATIONS

The present application is related to U.S. application 61/158,948 which was filed on 10 Mar. 2009, and to Singapore patent application 200901682-5 from which it claims priority.

### FIELD OF THE INVENTION

The present invention relates to identification of pairs of genes for which the respective gene expression values in a subject are statistically significant in relation to a medical condition, for example cancer, or more particularly breast cancer. The gene expression values may for example be indicative of the susceptibility of the subject to the medical condition, or the prognosis of a subject who exhibits the medical condition. The invention further relates to methods employing the identified gene pairs.

### BACKGROUND OF THE INVENTION

Global gene expression profiles of subjects are often used to obtain information about those subjects, such as their susceptibility to a certain medical condition, or, in the case of subjects exhibiting medical conditions, their prognosis. For example, having determined that a particular gene is important, the level in which that gene is expressed in a subject can be used to classify the individual into one of a plurality of classes, each class being associated with a different susceptibility or prognosis. The class comparison analysis leads to a better understanding of the disease process by identifying gene expression in primary tumours associated with subject survival outcomes (Kuznetsov et al., 2006).

Currently available clinical prediction and prognostic scores, such as the follicular lymphoma international prognostic index (LeBrun et al, 2008), or breast cancer aggressiveness scores (the St. Gallen consensus criterion or the Nottingham grading score (Ivshina et al, 2006)), are not able to optimally predict cancer aggressive dynamics or poor prognosis. On the other hand, genome-wide sequencing and expression technologies provide an enormous amount of information about genome and gene expression patterns associated with ethnology and pathogenesis of diseases, including cancers and other dangerous pathological process. However, these datasets provided by high-throughput technologies are still very noisy and biased so that selection of biologically meaningful and clinically essential genes and their products is imperative in further progress of diagnosis, prediction, prognosis and assignment of individual optimal therapy.

Furthermore, a given disease may exhibit many known and unknown genotype variations, which must be reliably defined on structural and functional levels. To this extent the task is twofold: first, the identification of reproducible, clinically-essential genetic (and phenotypic) sub-types of pathological cell types, and second the simultaneous optimal selection of the biologically meaningful genes. It is desirable to select genes (and or other markers) that correlate with survival time of the patients and provide in their combinations the best partition of the patients of relatively homogeneous distinct sub-groups of biological importance.

A gene and its products (mRNA transcripts, proteins) could be co-regulated and involved in many regulatory circuits, pathways and cellular programs which are very complex and poorly understood. However, several studies involving group analysis of expression profiles suggest that expression ratios of some gene pairs might be relatively reproducible indicators of the pathological process and, at the optimal thresholds for patient partition on to sub-groups, could be reliable prognostic indicators (Cui and Churchill, 2003; Motakis et al, 2008).

In some works, the combinations of individual gene pairs have been successfully used for diagnostics and prognosis (van't Veer, Sorlle et al, 2006; Ivshina et al, 2006). For example, In the work (LeBrun et al, 2008) the authors carried out so-called predictive interaction analysis (PIA) to examine whether any of the gene pairs generated from the very limited number of pres-selected genes (300 single genes) of follicular lymphoma were able to discriminate the 5-year outcomes more reliably than either single gene of the pair. Only gene pairs with both stringent and principal p-value gains of 10 times that of their respective single genes models were considered for further analysis. Of the 303 gene pairs that passed both criteria, the authors observed only 15 repeated gene pairs due to redundant features or genes represented by multiple probes on the array. The survival model in this and many other studies has been used only for validation of selected gene pairs. It was found that a high HOXB13/IL-17BR expression ratio is associated with increased relapse and death in patients with resected node-negative, ER-positive breast cancer treated with tamoxifen (Goetz et al, 2006). This case study showed that appropriate gene pairs may identify patients in whom alternative therapies should be studied.

However, several key questions remained outstanding:
(i) how to use survival analysis method(s) to select clinically synergistic gene pairs associated with a “hidden” subgroup of patients within a cohort, that is a subgroup of patients such that the pathological process indicates particular aggressiveness;
(ii) how to select the most appropriate statistical model of multivariate survival analysis which allows us to select the “survival significant” genes and synergistic gene pairs;
(iii) how, given that statistical model, to select the most “survival significant” genes (or other available variables) and biologically meaningful gene pairs among thousand of genes, and millions of gene pair combinations; and
(iv) how to define the noise background threshold(s) of the gene expression level ratios, which reliably reflect clinical heterogeneity even if the cohorts of individuals in our dataset include statistical imbalances of the patient groups.

We now present the background theory of survival analysis in more mathematical terms:

1. Analytical Method

First we will describe briefly the background theory of survival analysis. We denote by T the patient's survival time. T is a continuous non-negative random variable which can take values t, t∈[0, ∞). T has density function f(t) and cumulative distribution function F(t)=P(T≦t).

$$F ( t ) = {\int }_{0}^{t} f ( {t}^{′} ) d {t}^{′} .$$

We are primarily interested in estimating two quantities:

The survival function: S(t)=P(T>t)=1−F(t)

The hazard function:

$$h ( t ) = \frac{f ( t )}{S ( t )} = {lim}_{Δ t -> 0} \frac{P ( t \leq T < ( t + Δ t ) \vert T \geq t )}{Δ t}$$

The survival function expresses the probability of a patient to be alive at time t. It is often presented in the form S(t)=exp(−H(t)), where

$$H ( t ) = {\int }_{0}^{t} h ( u ) d u$$

denotes the cumulative hazard. The hazard function assesses the instantaneous risk of death at time t, conditional on survival up to that time.

Notice that the hazard function is expressed in terms of the survival function. To this extent, survival distributions and hazard functions can be generated for any distribution defined for t∈[0, ∞). By considering a random variable W, distributed in (∞, −∞), we can generate a family of survival distributions by introducing location (α) and scale (σ) changes of the form log T=α+σW.

Alternatively, we can express the relationship of the survival distribution to covariates by means of a parametric model. The parametric model employs a “regressor” variable x. Take for example a model based on the exponential distribution and write: log(h(t))=α+βx, or equivalently, h(t)=exp(α+βx).

This is a linear model for the log-hazard, or, equivalently, a multiplicative model for the hazard. The constant α represents the log-baseline hazard (the hazard when the regressor x=0) and the slope parameter β gives the change in hazard rate as x varies. This is an easy example of how survival models can be obtained from simple distributional assumptions. In the next paragraphs we will see more specific examples.

2. The Cox Proportional Hazards Model

One of the most popular survival models is the Cox proportional hazards model (Cox, 1972):

log h(t)=α(t)+βx

where, as before, t is the survival time, h(t) represents the hazard function, α(t) is the baseline hazard, β is the slope parameter of the model and x is the regressor. The popularity of this model lies in the fact that it leaves the baseline hazard function α(t) (which we may alternatively designate as log h₀(t)) unspecified (no distribution assumed). It can be estimated iteratively by the method of partial likelihood of Cox (1972). The Cox proportional hazards model is semi-parametric because while the baseline hazard can take any form, the covariates enter the model linearly.

Cox (1972) showed that the β coefficient can be estimated efficiently by the Cox partial likelihood function. Suppose that for each of a plurality of K subjects (labelled by k=1, . . . , K), we observe at corresponding time tₖ a certain nominal (i.e. yes/no) clinical event has occurred (e.g. whether there has been metastasis). This knowledge is denoted eₖ. For example eₖ may be 0 if the event has not occurred by time tₖ (e.g. no tumour metastasis at time tₖ) and 1 if the event has occurred (e.g. tumour metastasis at time tₖ). Cox (1972) showed that the β coefficient can be estimated efficiently by the Cox partial likelihood function, estimated as:

$$L ( {β}_{i} ) = {\prod }_{k = 1}^{K} {\{ \frac{exp ( β {x}_{k} )}{{\sum }_{j ∈ R ( {t}_{k} )} exp ( β {x}_{j} )} \}}^{{e}_{k}}$$

where R(tₖ)={j: tⱼ=tₖ} is the risk set at time tₖ.

3. Application of Cox Proportional Hazards Model to Expression Level Data

Suppose that, for a microarray experiment with i=1, 2, . . . , N genes, the intensities are measured for k=1, 2, . . . , K subjects. The measure of the intensity of gene i (i.e. the expression value of gene i) in subject k may be denoted as y_{i,k}. This may be a direct expression value measurement, or some transformed value derived from it such as a logarithm of an expression value measurement. Denote the chance of survival of a given individual as hₖ(t), then the Cox proportional-hazards model is that:

$$log {h}_{k} = α ( t ) = {\sum }_{i = 1}^{N} {β}_{i} {y}_{i , k}$$

where α(t) is unspecified and βᵢ, i=1, . . . N, is a set of N parameters. Each βᵢ is a measure of the significance of the corresponding gene i. The set of N values βᵢ can be considered as a 1×N vector of regression parameters denoted by β.

It is known to divide the group of patients into “high-risk” and “low risk” groups using a set of parameters {cⁱ} according to whether:

$${x}_{k}^{i} = \{ \begin{matrix}1 ( high risk ) , & if {y}_{i , k} > {c}^{i} \\ 0 ( low risk ) , & if {y}_{i , k} \geq {c}^{i}\end{matrix}$$

The values {cⁱ} may be referred to as “cut-off expression values”.

In this case, the Cox proportional hazard regression model becomes (Cox, 1984):

log hⁱₖ(tₖ|xₖⁱ, βᵢ)=αᵢ(tₖ)+βᵢ·xₖⁱ,

where hⁱₖ is the hazard function and αᵢ(tₖ) represents the unspecified log-baseline hazard function; β is the 1×N regression parameters vector with components βᵢ; and tₖ is the subjects' survival time.

A Wald statistic, corresponding to a partial likelihood for each of the βᵢ, may estimated for each gene i as:

$$L ( {β}_{i} ) = {\prod }_{k = 1}^{K} {\{ \frac{exp ( {β}_{i}^{T} {x}_{k}^{i} )}{{\sum }_{j ∈ R ( {t}_{k} )} exp ( {β}_{i}^{T} {x}_{j}^{i} )} \}}^{{e}_{k}}$$

where R(tₖ)={j: tⱼ=tₖ} is the risk set at time tₖ.

4. Mean-Based Grouping (MBg)

One specific example of this procedure is Mean-based grouping (MBg). The following procedure is performed successively for i=1, 2, . . . , N.
1. For i=1, estimate the mean expression signal μᵢ and then group the k=1, 2, . . . , K patients according to

$${x}_{k}^{i} = \{ \begin{matrix}1 ( high risk ) & if {y}_{i , k} > {c}^{i} \\ 0 ( low risk ) , & if {y}_{i , k} \geq {c}^{i}\end{matrix}$$

with cⁱ=μᵢ.
2. Evaluate the prognostic significance of gene i by reporting the p-value of the estimated βᵢ from the model

log hⁱₖ(tₖ|xₖⁱ, βᵢ)=αᵢ(tₖ)+βᵢ·xₖⁱ
3. Perform steps 1 and 2 successively for all genes i=2, . . . , N.
4. Select as prognostic significant the genes with significantly small p-values (p<α=1%). Here α is the significance level of the test for each gene i: gene i is regarded as significant if p is below α.

5. Alternatives to a Cox Proportional Hazards Model

Table 1 lists a number of known parametric survival models which are alternatives to the Cox proportional Hazards model. The survival function S(t)=P(T>t) defines the probability of an individual to survive after time t.

Each of the survival models employ one or more parameters λ, γ, μ, σ which are fixed, in the sense that these values are selected so as to fit the survival model to a given data-set, such that the survival function then varies only with the regressor.

The first four survival models in Table 1 make a proportional hazards assumption. The last two do not. Note that the Hazard functions for the six survival models are what we will call here “structurally different”. In other words, they differ not only in the values which certain fixed parameters take, but in the form of the mathematical function. In other words, the survival models cannot be transformed from one into another by a revaluing of any of the parameters.

TABLE 1

| Survival Model | | | Proportional hazards |
|---|---|---|---|
| (distribution of t) | Survival Function S(t) | Hazard function h(t) | assumption |
| Exponential | S(t) = e^{-λt} | h(t) = λ | YES |
| Weibull | S(t) = e^{(-λt)}^{^{γ}} | h(t) = λγ(λt)^{γ} | YES |
| Gaussian | $S ( t ) = 1 - Φ ( \frac{t - μ}{σ} )$ | $h ( t ) = \frac{ϕ ( t - μ )}{Φ ( - t )}$ | YES |
| Logistic | $S ( t ) = {e}^{\frac{λ {e}^{γ t}}{γ}}$ | h(t) = λe^{γt} | YES |
| Loglogistic | $S ( t ) = \frac{1}{1 + {( λ t )}^{γ}}$ | $h ( t ) = \frac{{λγ ( λt )}^{γ - 1}}{1 + {( λt )}^{γ}}$ | NO |
| Lognormal | $S ( t ) = 1 - Φ ( \frac{log t - μ}{σ} )$ | $h ( t , σ ) = \frac{( \frac{1}{t σ} ) ϕ ( \frac{log t - μ}{σ} )}{Φ ( \frac{- log t}{σ} )}$ | NO |

Φ is the cumulative distribution function of the standard normal distribution and φ is the probability density function of the standard normal distribution.

Yet another known model is a “stratified Cox model” as proposed by Kalbfleisch and Prentice, 1980. In this model,

log h_{k,g}ⁱ(tₖ,xₖⁱ)=α_{i,g}(tₖ)+β_{i,g}xₖⁱ, g=1, 2, . . . , G

where g labels G “strata”.

This modification of the Cox regression model includes the stratification of a covariate that does not satisfy the proportional hazards assumption. It assumes that there is one variable that does not satisfy the proportional hazards. The modification creates strata for this one variable, and within these strata estimates the effect of grouping on survival times. Covariates that are assumed to satisfy the proportional hazards assumption are included in the model, whereas the predictor being stratified is not included.

### SUMMARY OF THE INVENTION

The present invention aims to provide new and useful methods for identifying genes which are statistically significant in relation to a medical condition. It further aims to provide new and useful methods for identifying statistical models employing data about the expression levels of the identified genes. It further suggests gene pairs which are statistically significant for certain medical conditions.

A first aspect of the invention proposes in general terms that, for a given set of patient data, there is a process of selecting from a plurality of survival models, which survival model best models a set of clinical data. In each of the multiple survival models, the hazard function is a structurally-different mathematical function of the time variable or other exogenous variables, i.e. the functions differ not only in that they include respective parameter(s) which take different respective values, but in that the hazard functions of the functions have a different functional dependency on the regressor variables (e.g. time). For example, one of the models is typically a Cox proportional hazards model, while another may be one of the other models specified in Table 1. For example, one or more of the survival models may be proportional survival models, and one or more of the survival models may be non-proportional survival models.

In one form, there may first be a step of determining whether the data set fits a single survival model (e.g. such that a numerical measure of the quality of the fit is above a predetermined level), and if it is found not to fit, one or more other survival models are tried out. In one example, the single survival model may be one involving proportional hazards, and the step of determining whether the data set fits the survival model may include determining whether the proportional hazards assumption holds.

The criterion for selecting which of the survival models best fits the data set may employ the Bayesian Information Criterion (BIC).

A first possible expression of the first aspect of the invention is a computerized method for identifying one or more genes, or pairs of genes, selected from a set of N genes, which are statistically associated with prognosis of a potentially fatal medical condition, the method employing test data which, for each subject k of a set of K subjects suffering from the medical condition, indicates (i) a survival time of subject k, and (ii) for each gene i, a corresponding gene expression value y_{i,k} of subject k;

the method comprising:
(i) for each of a plurality of genes or pairs of genes, performing the sub-steps of:
   (a) partitioning the K subjects into two subsets using cut-off values, and computationally fitting the corresponding survival times of at least one of the subsets of subjects to a Cox proportional hazard regression model;
   (b) determining whether a proportionality assumption of the Cox proportional hazard regression model is satisfied;
   (c) if the proportionality assumption is not satisfied, fitting the data-set to at least one additional statistical model which does not satisfy a proportionality assumption; and
   (d) obtaining a significance value indicative of prognostic significance of the gene or gene pair;
(ii) identifying one or more of the genes or pairs of genes for which the corresponding significance values have the highest prognostic significance.

Another possible expression of the first aspect of the invention is a computerized method for identifying one or more genes, or pairs of genes, selected from a set of N genes, which are statistically associated with prognosis of a potentially fatal medical condition, the method employing test data which, for each subject k of a set of K subjects suffering from the medical condition, indicates (i) a survival time of subject k, and (ii) for each gene i, a corresponding gene expression value y_{i,k} of subject k;

the method comprising:
(i) for each of a plurality of genes or pairs of genes, performing the sub-steps of:
   (a) computationally fitting the test data to a plurality of regression models, each model partitioning the K subjects into two subsets using cut-off values;
   (b) identifying which of the regression models best fits the test-data according to a data fit measure, such as the Bayesian Information Criterion; and
   (c) using the identified regression model to obtain a significance value indicative of prognostic significance of the gene or gene pair; and
(ii) identifying one or more of the genes or pairs of genes for which the corresponding significance values have the highest prognostic significance.

A second aspect of the invention relates, in general terms, to a survival model which, for each of one or more pairs of genes, is a function of a measure of the ratio of expression levels of the pair of genes. For each pair of genes, there is a corresponding a cut-off value, such that patients are classified according to whether the corresponding measure is above or below the cut-off value. The second aspect of the invention proposes that the cut-off value should be selected so as to maximize the separation of the respective survival curves of the two groups of patients. From another point of view, this means that the cut-off value is selected such that the partition of subjects which it implies is of maximal statistical significance. One embodiment of the first aspect of the invention is referred to below as “DDgR”.

One possible expression of this aspect of the invention is a computerized method for identifying one or more pairs of genes, selected from a set of N genes, which are statistically associated with prognosis of a potentially fatal medical condition, the method employing test data which, for each subject k of a set of K subjects suffering from the medical condition, indicates (i) a survival time of subject k, and (ii) for each gene i, a corresponding gene expression value y_{i,k} of subject k;

the method comprising:
(i) for each of a plurality of pairs of genes (i, j with i≠j), generating a respective plurality of a trial cut-off values of c_{i,j}, and for each of the trial cut-off values:
   (a) partitioning the K subjects into two subsets according to whether log(y_{i,k})−log(y_{j,k}) is respectively above or below the trial cut-off value c_{i,j};
   (b) computationally fitting the corresponding survival times of at least one of the subset of subjects to a Cox proportional hazard regression model; and
   (c) obtaining a significance value indicative of prognostic significance of the gene pair i,j;
(ii) for each of the pairs of genes, identifying the trial cut-off value for which the corresponding significance value indicates the highest prognostic significance for the gene pair i,j; and
(iii) identifying one or more of the pairs of genes i,j for which the corresponding significance values have the highest prognostic significance.

A certain embodiment of the invention relates to the usage of gene pairs identified by a method according to the first and/or second aspects of the invention. It further relates to programmed computers capable of performing the methods (any general purpose computer may be used for this purpose), and to data-carriers (such as tangible media, such as CDs) carrying software instructions for performing the method.

A third aspect of the invention proposes obtaining information about a first subject in relation to breast cancer, by measuring in the first subject the expression levels of a pair of genes in one of the rows of Table 2 below, or one of the pairs of genes in Table 10 later in this document, and obtaining the information using a statistical model which employs the expression levels of those genes.

This third aspect of the invention further proposes a microarray (or other kit) for obtaining data for performing prognosis of breast cancer. Since the microarray is dedicated to this purpose it does not require sensing of large numbers of genes which are not of significance. Instead, its cost can be reduced by designing it only to sense the presence of a limited number of genes (e.g. at most 100 genes, at most 50 genes, or at most 30 genes, or at most 20 genes) of which some or all have been determined to be a specific relevance to breast cancer.

One specific expression of this method is a microarray being for measuring the expression value of a set of no more than 20 genes (or not more than 100, or no more than 50, or no more than 30), including at least one of the pairs of genes which are the rows of Table 2.

TABLE 2

| | |
|---|---|
| TUBB3 | KIAA0999 |
| SPG20 | PGAM1 |
| H2AFZ | RBM35B |

Another specific expression of this method is a microarray (or other kit) for measuring the expression value of a set of no more than 20 genes (or not more than 100, no more than 50, or no more than 30) including at least one of the 16 pairs of genes which are respectively given in the upper 17 rows of Table 10, and preferably more than one of these pairs.

### DETAILED DESCRIPTION OF THE EMBODIMENTS

Embodiments of the invention will now be explained, with reference to the following figures in which:

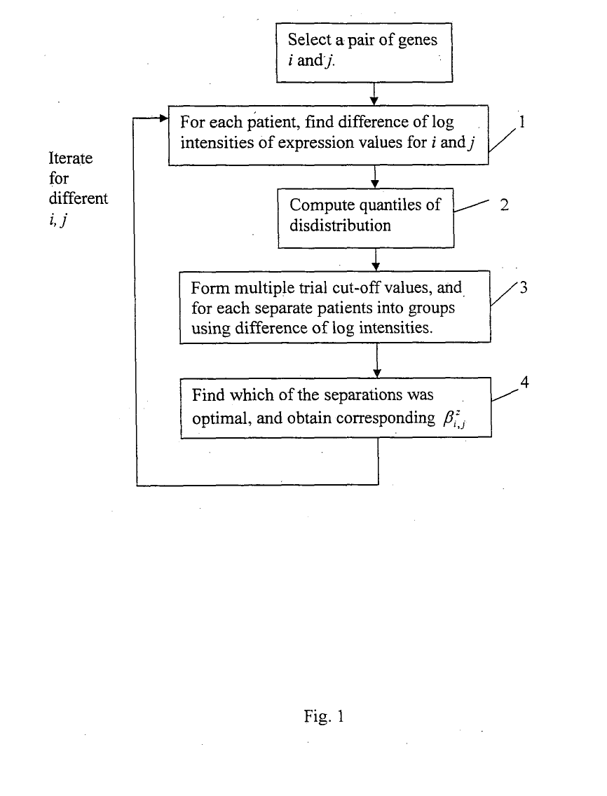

FIG. 1 is flow diagram of a method (“DDgR”) which is an embodiment of the invention.

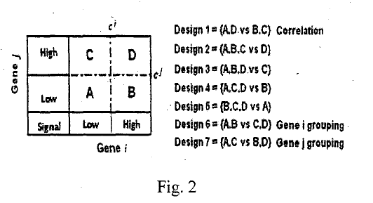

FIG. 2 is a diagram used to explain the technique of “2-Dimensional” patient grouping.

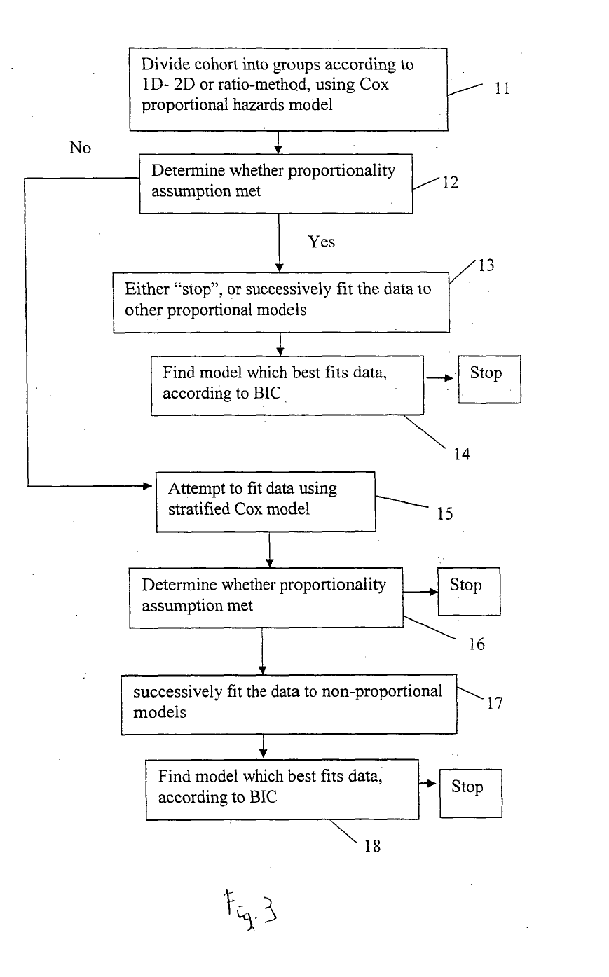

FIG. 3 is a flow diagram of a method which is a second embodiment of the invention.

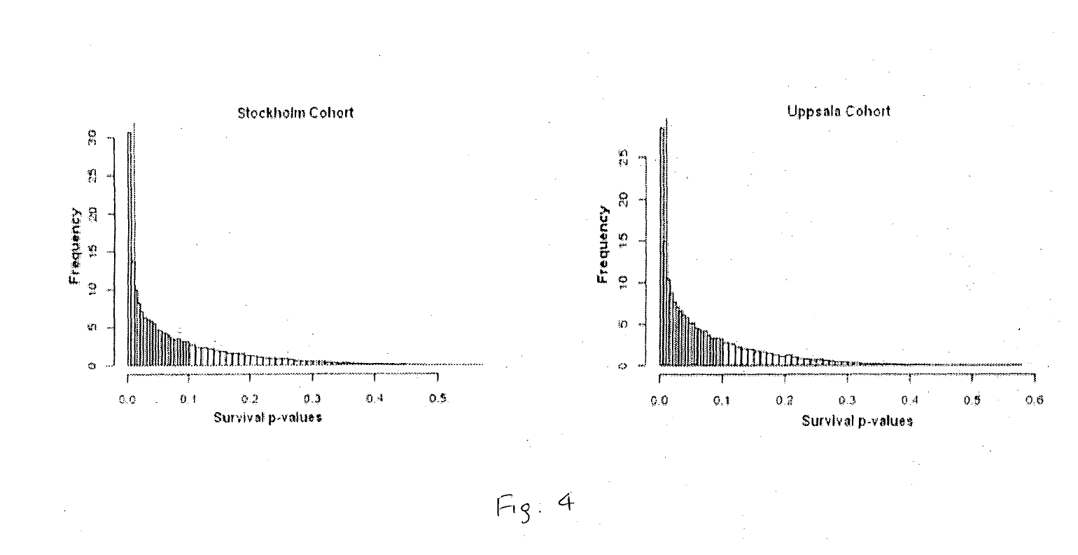

FIG. 4 shows the distribution of survival p-values for Stockholm cohort (left panel) and Uppsala cohort (right panel) of 44928 probesets. The vertical dashed line at p=0.01 denotes the 1% significance level below which we declare a probe as survival significant.

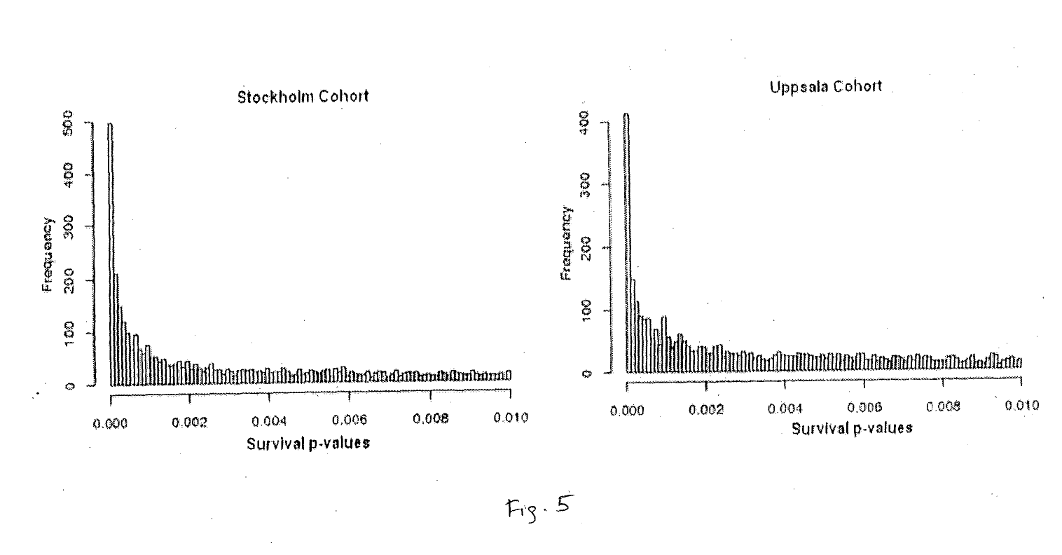

FIG. 5 shows the distribution of survival significant p-values for Stockholm cohort (left panel) and Uppsala cohort (right panel) of common 3375 probesets of the two cohorts.

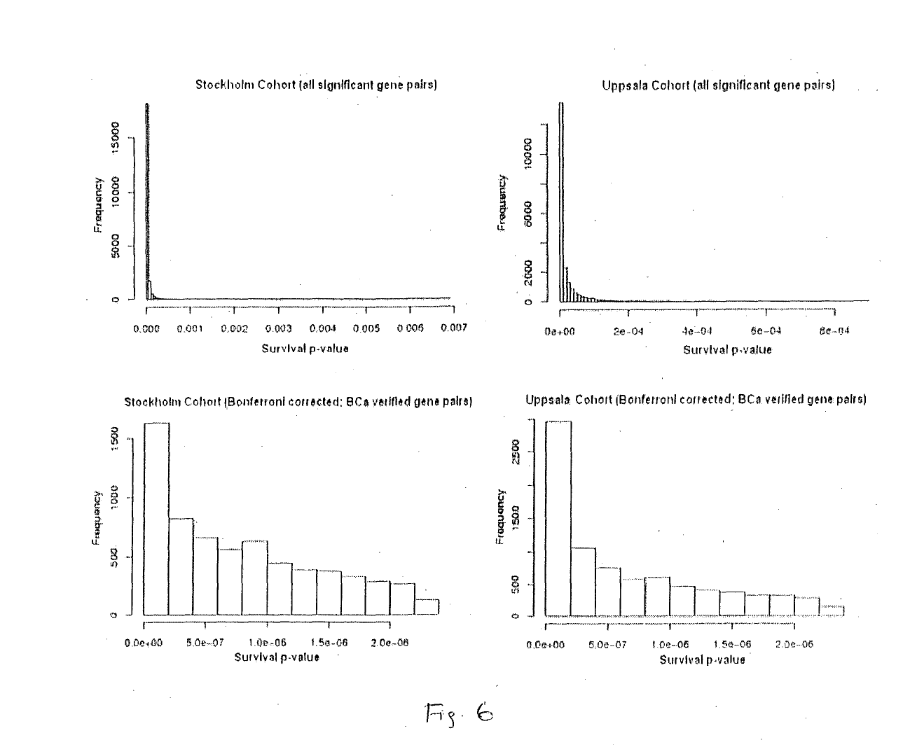

FIG. 6 shows the distribution of survival p-values of 20665 reproducible across cohort gene pairs in Stockholm (left top panel) and Uppsala (right top panel). Distribution of survival p-values of Bonferroni corrected and BCa-significant gene pairs in Stockholm (left bottom panel) and Uppsala (right bottom panel).

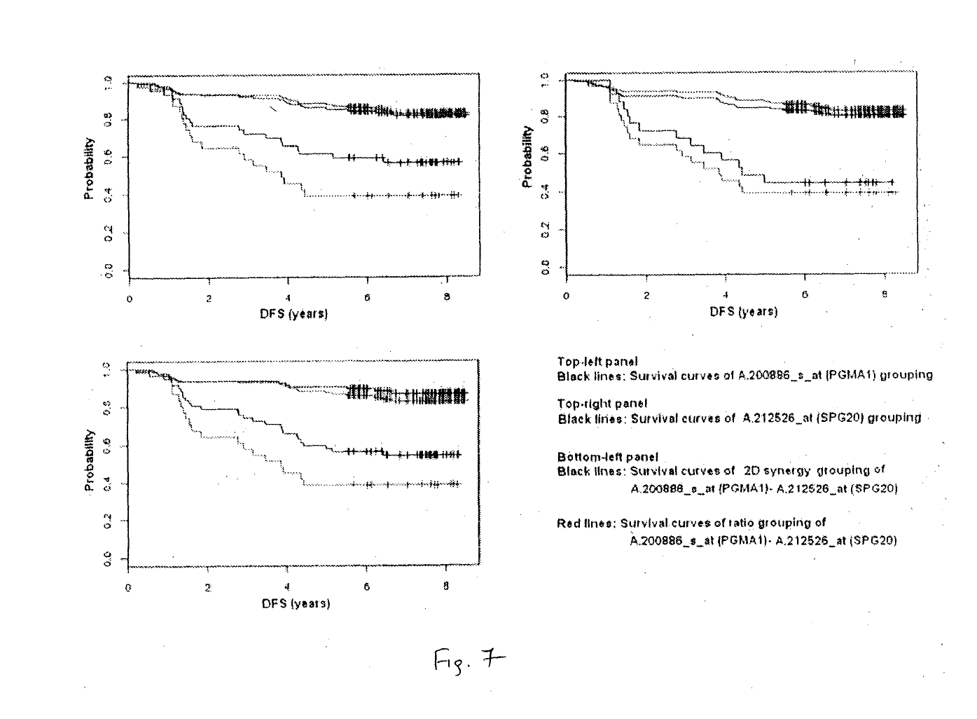

FIG. 7 shows Kaplan-Meier survival curves of in Stockholm cohort for PGMA1 and SPG20 genes. Top-left panel: p-value of PGMA1 grouping=6.2E-04; top-right panel: p-value of SPG20 grouping=1.1E-04; bottom-left panel: 2D synergy p-value of PGMA1-SPG20 grouping=1.5E-05 and ratio PGMA1/SPG20 grouping p-value=9.7E-08.

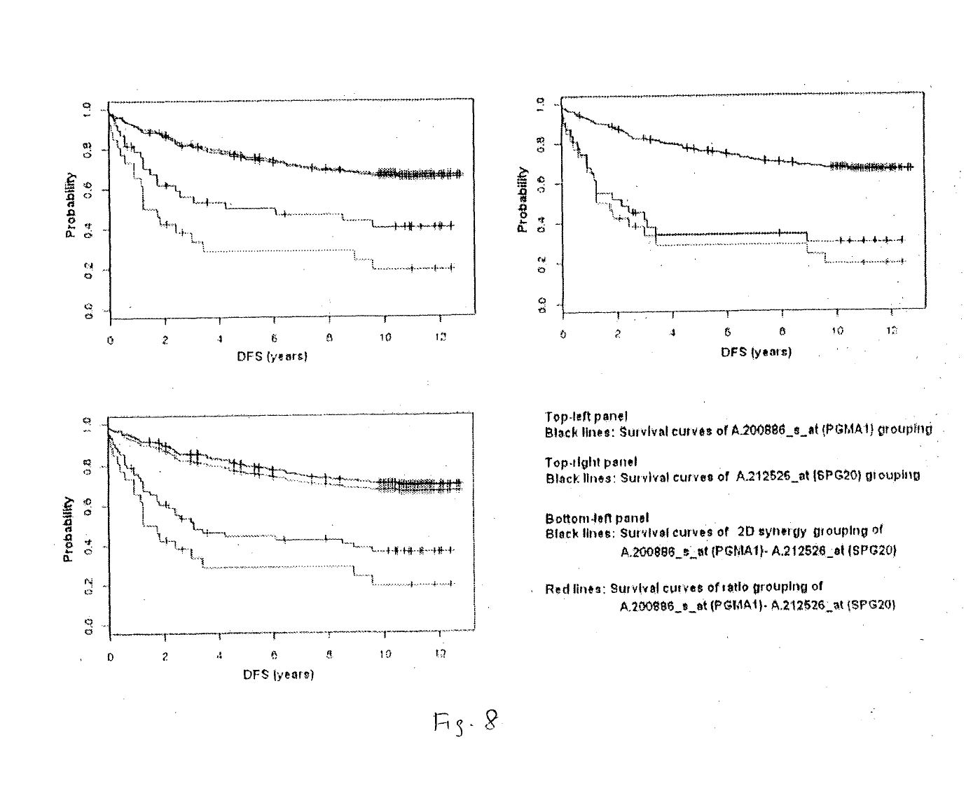

FIG. 8 shows Kaplan-Meier survival curves of in Uppsala cohort for PGMA1 and SPG20 genes. Top-left panel: pvalue of PGMA1 grouping=9.4E-04; top-right panel: p-value of SPG20 grouping=6.8E-07; bottom-left panel: 2D synergy p-value of PGMA1-SPG20 grouping=9.5E-08 and ratio PGMA1/SPG20 grouping pvalue=5.3E-09.

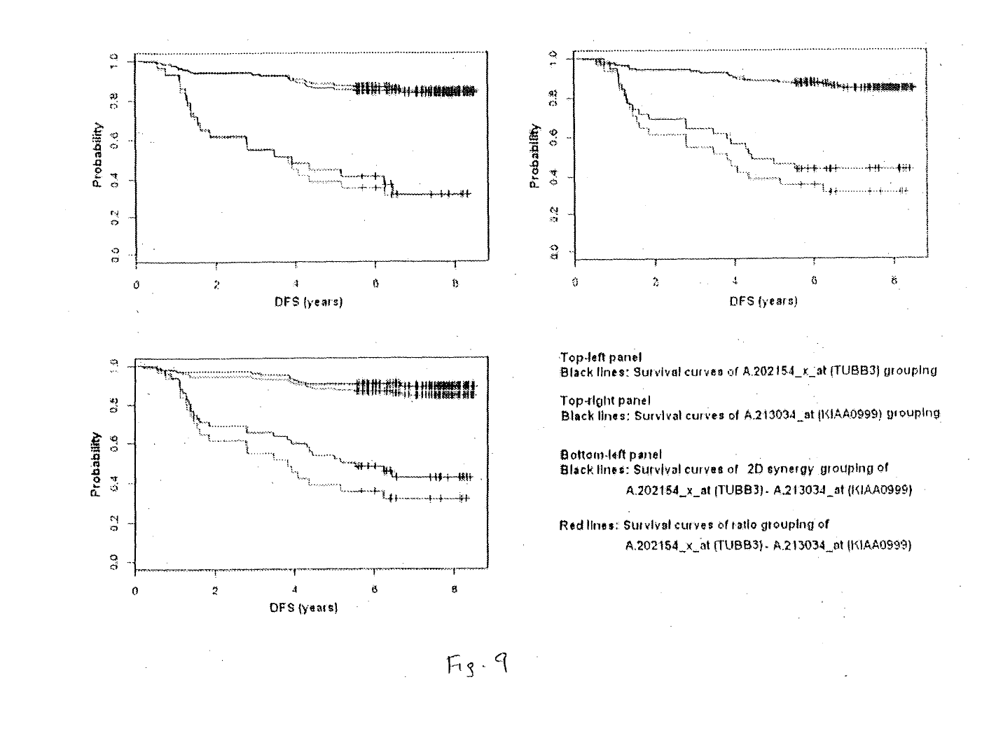

FIG. 9 shows Kaplan-Meier survival curves of in Stockholm cohort for TUBB3 and KIAA0999 genes. Top-left panel: p-value of TUBB3 grouping=2.1E-08; top-right panel: p-value of KIAA0999 grouping=2.2E-07; bottom-left panel: 2D synergy p-value of TUBB3-KIAA0999 grouping=1.3E-08 and ratio TUBB3/KIAA0999 grouping p-value=8.2E-10.

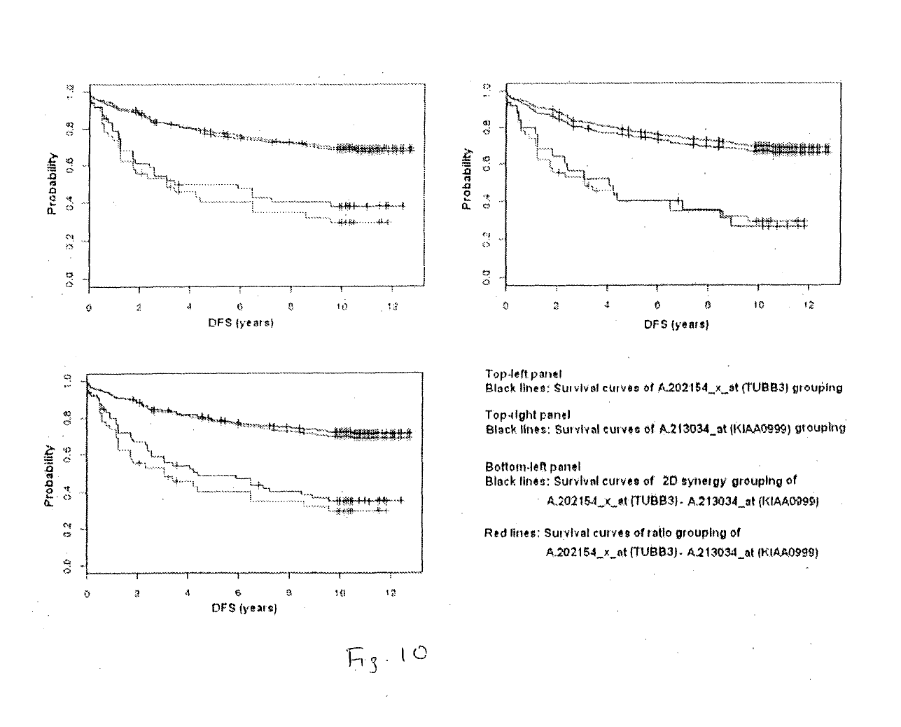

FIG. 10 shows Kaplan-Meier survival curves of in Uppsala cohort for TUBB3 and KIAA0999 genes. Top-left panel: p-value of TUBB3 grouping=2.7E-05; top-right panel: p-value of KIAA0999 grouping=4.0E-05; bottom-left panel: 2D synergy p-value of TUBB3-KIAA0999 grouping=1.4E-07 and ratio TUBB3/KIAA0999 grouping p-value=3.3E-08.

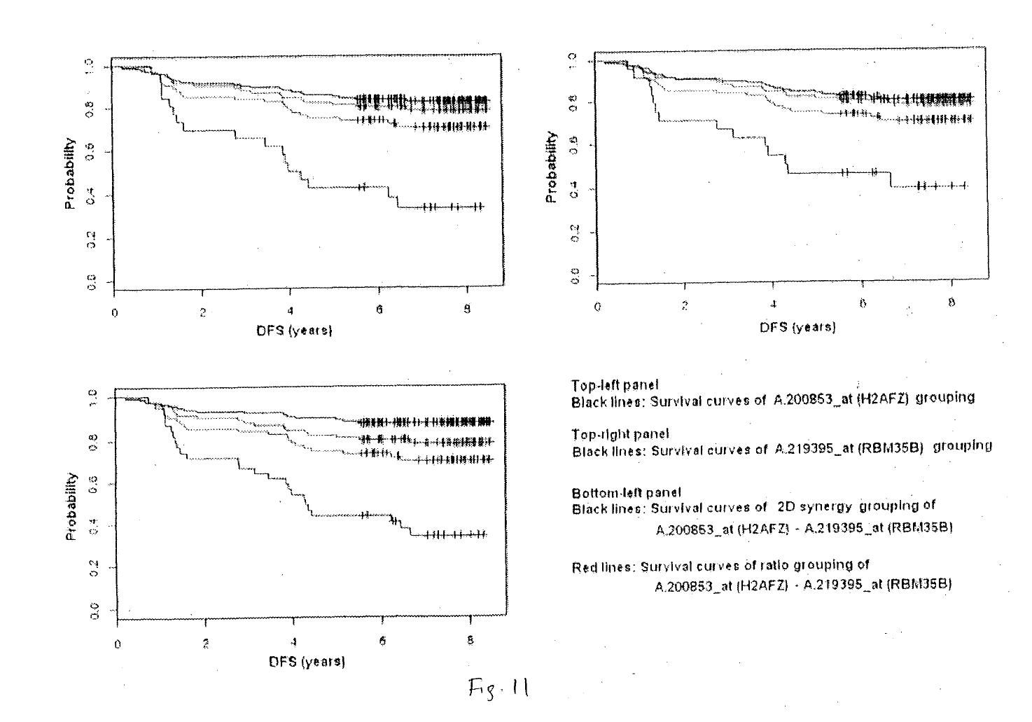

FIG. 11 shows Kaplan-Meier survival curves of in Stockholm cohort for H2AFZ and RBM35B genes. Top-left panel: p-value of H2AFZ grouping=3.3E-07; top-right panel: p-value of RBM35B grouping=2.9E-05; bottom-left panel: 2D synergy p-value of H2AFZ - RBM35B grouping=2.1E-07 and ratio H2AFZ/RBM35B grouping p-value=2.5e-01.

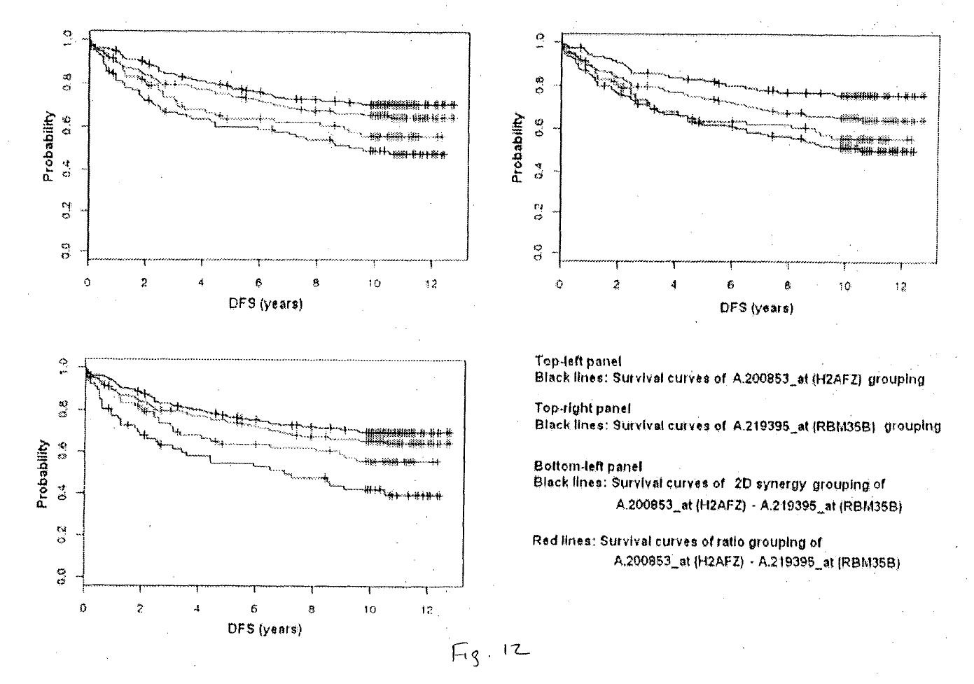

FIG. 12 shows Kaplan-Meier survival curves of in Uppsala cohort for H2AFZ and RBM35B genes. Top-left panel: p-value of H2AFZ grouping=3.6E-04; top-right panel: p-value of RBM35B grouping =1.3E-04; bottom-left panel: 2D synergy p-value of H2AFZ-RBM35B grouping=3.5E-11 and ratio H2AFZ/RBM35B grouping p-value=1.9e-01.

### DEFINITIONS

“Array” or “microarray,” as used herein, comprises a surface with an array, preferably an ordered array, of putative binding (e.g., by hybridization) sites for a sample which often has undetermined characteristics. An array can provide a medium for matching known and unknown nucleic acid molecules based on base-pairing rules and automating the process of identifying the unknowns. An array experiment can make use of common assay systems such as microplates or standard blotting membranes, and can be worked manually, or make use of robotics to deposit the sample. The array can be a macro-array (containing nucleic acid spots of about 250 microns or larger) or a micro-array (typically containing nucleic acid spots of less than about 250 microns).

The term “cut-off expression value” represented by cᵢ refers to a value of the expression level of a particular nucleic acid molecule (or gene or probe) i in a subject. The cut-off expression value is used to partition the subjects into classes, according to whether the expression level of the corresponding gene is below or above the cut-off expression value. Note that it makes no difference whether all subjects for which the expression value is actually equal to the cut-off value are classified as being in one class or alternatively in the other. The term “cut-off value” is used for variables such as c_{i,j} where the cut-off is used to classify based on a value other than the expression value of one nucleic acid molecule (or gene or probe), such as the ratio of the expression values two nucleic acid molecules i, j.

The term “gene” refers to a nucleic acid molecule that encodes, and/or expresses in a detectable manner, a discrete product, whether RNA or protein. It is appreciated that more than one nucleic acid molecule may be capable of encoding a discrete product. The term includes alleles and polymorphisms of a gene that encodes the same product or an analog thereof.

There are various methods for detecting gene expression levels. Examples include Reverse-Transcription PCR, RNAse protection, Northern hybridisation, Western hybridisation, Real-Time PCR and microarray analysis. The gene expression level may be determined at the transcript level, or at the protein level, or both. The nucleic acid molecule or probe may be immobilized on a support, for example, on an array or a microarray. The detection may be manual or automated. Standard molecular biology techniques known in the art and not specifically described may be employed as described in Sambrook and Russel, Molecular Cloning: A Laboratory Manual, Cold Springs Harbor Laboratory, New York (2001).

Gene expression may be determined from sample(s) isolated from the subject(s).

Algorithms referred to as R-algorithms, or routines “in the R library”, refer to algorithms in the package described at http://cran.r-project.org/, or written in the language of the environment described there.

### DETAILED DESCRIPTION OF THE EMBODIMENTS

Embodiments of the invention will now be explained. Before doing so, we discuss a technique (“DDg”) which was not in the public domain at the priority date of the present application, and which is not independently claimed in the present application (it is described in detail in one of the related patent applications referenced above), but which is employed in certain embodiments of the present invention.

### 1. Data-Driven Grouping (DDg)

DDg is an alternative to the mean-based grouping (MBg) explained in the background section of the present application. The explanation of it given below uses terms with the same definition as in the explanation of MBg above.

For each gene i, compute the 10th quantile (q₁₀ⁱ) and the 90th quantile (q₉₀ⁱ) of the distribution of the K signal intensity values (i.e. the expression levels of the K patients). Within (q₁₀ⁱ, q₉₀ⁱ), we search for the value that most successfully discriminates the two unknown genetic classes. This can be done by the following steps:
1. Form the candidate cut-offs vector of dimension 1×Q, wⁱ=yᵢ^{w}, where yᵢ^{w} is the log-transformed intensities within (q₁₀ⁱ, q₉₀ⁱ) and Q is the number of elements in wⁱ. Each element of the wⁱ is a trial cut-off value. For i=1 and cⁱ=w_{z}ⁱ, z=1, . . . , Q use

$${x}_{k}^{i} = \{ \begin{matrix}1 ( high \text{-} risk ) & if {y}_{i , k} > {c}^{i} \\ 0 ( low \text{-} risk ) , & if {y}_{i , k} \leq {c}^{i}\end{matrix}$$

to separate the K subjects with cⁱ.
2. For z=1 (the first element in wⁱ) evaluate the prognostic significance of gene i given cut-off w_{z}ⁱ by estimating the βᵢ^{z} from log hₖⁱ(tₖ|xₖⁱ, βᵢ^{z})=αᵢ(tₖ)÷βᵢ^{z}xₖⁱ and

$$L ( {β}_{i}^{z} ) = {\prod }_{k = 1}^{K} {\{ \frac{exp ( {β}_{i}^{z} {x}_{k}^{i} )}{\text{?} exp ( {β}_{i}^{z} {x}_{k}^{i} )} \}}^{{e}_{k}} . \\ \text{?} \text{indicates text missing or illegible when filed}$$

3. Iterate for z=2, . . . , Q to estimate the Q p-values (corresponding to Q distinct cut-off expression value levels) for each i. The “optimal” cut-off expression value cⁱ for each i is the taken as the one with the minimum βᵢ^{z} [symbol] p-value, provided that the sample size of each group is sufficiently large (formally above 30) and Cox proportional hazards model is plausible.
4. Iterate steps 1 to 3 for i=2, . . . , N.

### 2. Data-Driven Grouping for Ratios (DDgR)

We now turn to an embodiment of the invention, illustrated by the flow diagram of FIG. 1. Ratio-based approaches have previously been used for the analysis of microarray data (e.g. normalization and differential expression analyses; see Cui and Churchill, 2003). Here, we develop a grouping method based on ratios and compare it against our data driven method (DDg) for individual genes. We claim that the ratio approach can significantly improve the biological classification and thus provide useful predictions of the clinical assignment of breast cancer patients.

Data-driven grouping for ratios is an extension of our original Data-driven method that takes into account ratios of intensities. Instead of considering each gene independently and attempting to identify the respective patients' grouping, this new approach takes into account ratios of raw gene intensities (or equivalently the difference of gene log-transformed intensities), which are then processed in the same way as in the DDg method. To this extent, the ratio-based approach utilizes pairs of genes (instead of single genes) and aims to identify significantly different groups of cancer patients. The steps of the algorithm are as follows:
1. Compute the difference of log-transformed intensities of two selected genes i and j (step 1 of FIG. 1).
2. Compute the quantile (q₁₀^{i,j}) and the 90th quantile (q₉₀^{i,j}) of the distribution of the K log-difference values y_{i,k}−y_{j,k} (step 2 in FIG. 1).
3. Within (q₁₀^{i,j}, q₉₀^{i,j}) search for the cut-off value that most successfully discriminates the two unknown genetic classes, by forming the candidate cut-offs vector of dimension 1×Q, w^{i,j}=yᵢⱼ^{w}, where yᵢⱼ^{w} is the log-differenced intensities y_{i,k}−y_{j,k} [symbol] within (q₁₀^{ij}, q₉₀^{ij}) and Q is the number of elements in w^{ij}. Each element of the w^{ij} is a trial cut-off value. For i=1 and c^{ij}=w_{z}^{ij}, z=1, . . . , Q use

$${x}_{k}^{ij} = \{ \begin{matrix}1 ( high \text{-} risk ) & if {y}_{i , k} - {y}_{j , k} > {c}^{ij} \\ 0 ( low \text{-} risk ) & if {y}_{i , k} - {y}_{j , k} \leq {c}^{ij}\end{matrix}$$

to separate the K subjects with c^{ij}. This is step 3 of FIG. 1.
4. For z=1 (the first element in wⁱ) evaluate the prognostic significance of gene pair i,j given the cut-off c^{ij} by βᵢⱼ^{z} estimating the form

log hₖ^{ij}(tₖ|xₖ^{ij}, βᵢⱼ^{z})=αᵢⱼ(tₖ)÷βᵢⱼ^{z}xₖ^{ij} and

$$L ( {β}_{ij}^{z} ) = {\prod }_{k = 1}^{K} {\{ \frac{exp ( {β}_{ij}^{z} {x}_{k}^{ij} )}{{\sum }_{j ∈ R ( {t}_{k} )} exp ( {β}_{ij}^{z} {x}_{k}^{ij} )} \}}^{{e}_{k}}$$

5. Iterate steps 1 to 4 for z=2, . . . , Q to estimate the Q p-values (corresponding to Q distinct cut-off levels) for each i and j. The “optimal” cut-off value for each pair is the one with the minimum βᵢⱼ^{z} p-value, provided that the sample size of each group is sufficiently large (formally above 30) and the Cox proportional hazards model is plausible. This is step 4 of FIG. 1.
6.Iterate steps 1-5 for the selected i and j pairs.

Statistically significant gene pairs are identified as those having low β_{i,j}^{z} p-values.

### 3. 2-Dimensional (“2-D”) Patient Grouping

Before discussing further embodiments of the invention we now discuss the concept of 2-dimensional patient grouping. Again, this idea is not independently claimed in the present application (it is described in detail in one of the related patent applications referenced above), but it is employed in certain embodiments of the present invention.

The idea of 2-D grouping, in general terms is that that pairs of genes are selected. For each gene pair, we use a respective cut-off value for each gene to generate a plurality of models, which represent ways of partitioning a set of subjects based on the expression values of the pair of genes in relation to the respective cut-off values. We then identify those gene pairs for which one of the models has a high prognostic significance. Specifically, the models are defined using the scheme illustrated in FIG. 2, where they are referred to respectively as “designs 1-7”.

Specifically, for a given gene pair i, j, i≠j, and respective individual cut-off expression values cⁱ and c^{j}, we define seven “models”, each of which is a possible way in which the expression levels of the two genes might be significant. Then we test the data to see if any of the seven models are in fact statistically significant. The models are defined using FIG. 2 which shows how a 2-D area having y_{i,k}, y_{j,k} as axes. In FIG. 2 gene i is referred to as “gene 1” and gene j as “gene 2”. The 2-D area is divided into four regions A, B, C and D, defined as follows:
A: y_{i,k}<cⁱ and y_{j,k}<c^{j}
B: y_{i,k}≧cⁱ and y_{j,k}<c^{j}
C: y_{i,k}<cⁱ and y_{j,k}≧c^{j}
D: y_{i,k}≧cⁱ and y_{j,k}≧c^{j}

Each of the seven models is then defined as a respective selection from among the four regions:

Model 1 is that a subject's prognosis is correlated with whether the subject's patient's expression levels are within regions A or D, rather than B or C.

Model 2 is that a subject's prognosis is correlated with whether the subject's patient's expression levels are within regions A, B or C, rather than D.

Model 3 is that a subject's prognosis is correlated with whether the subject's patient's expression levels are within regions A, C or D, rather than B.

Model 4 is that a subject's prognosis is correlated with whether the subject's patient's expression levels are within regions B, C or D, rather than A.

Model 5 is that a subject's prognosis is correlated with whether the subject's patient's expression levels are within regions A, B or D, rather than C.

Model 6 is that a subject's prognosis is correlated with whether the subject's patient's expression levels are within regions A or C, rather than B or D.

Model 7 is that a subject's prognosis is correlated with whether the subject's patient's expression levels are within regions A or B, rather than C or D.

Note that model 6 is equivalent to asking only whether the subject's expression level of gene 1 is below of above c¹ (i.e. it assumes that the expression value of gene 2 is not important). Model 7 is equivalent to asking only whether the subject's expression for gene 2 is above or below c² (it assumes that the expression value of gene 1 is not important). Thus, models 1-5 are referred to as “synergetic” (1-5), and the models 6 and 7 as “independent”.

The 2-D patient grouping evaluates the significance of all possible gene pairs i, j as follows:
1. Set i=1 and j=2.
2. For each of the 7 models, obtain the respective sub-set of the subjects whose expression values for genes i and j obey the respective set of the conditions shown in FIG. 1. For example, for model 1, we obtain the subset of the K subjects whose expression values obey conditions A, B or C. This is the subset of the subjects for which y_{i,k}<cⁱ and/or y_{j,k}<c^{j} (i.e. the set of subjects which for which condition D is not obeyed). Let us define a parameter x_{i,j,k}^{m}, where x_{i,j,k}^{m}=1 if and only if, for genes i and j, and model m (m=1, . . . 7), the expression levels y_{i,k} and y_{j,k} meet the conditions of model m.
3. Fit the survival values to:

log h^{i,j}ₖ(tₖ|x_{i,j,k}^{m},β_{i,j}^{m})=α_{i,j}(tₖ)+β_{i,j}^{m}·x_{i,j,k}^{m},
4. Estimate the seven Wald p-values β_{i,j}^{m}. Provided that the respective groups sample sizes are sufficiently large and the assumptions of the Cox regression model are satisfied, the model is the one with the smallest β_{i,j}^{m} p-value.
5. Iterate steps 1 to 4 for all pairs of genes.

“2-D patient grouping” is grouping of K patients based on a pair of genes exhibiting potential interaction in context of survival time. “1-D grouping” is grouping of K patients based on individual genes. In view of the term “2-D patient grouping”, DDg can be considered as more general and biologically meaningful approach than “1-D grouping”, in which each gene is considered individually. Strictly speaking, MBg is a kind of 1-D grouping but it does not estimate the optimal cut-off. The optimal cut-off is estimated only by the DDg method.

### 4. Residuals Bootstrap for the Cox Proportional Hazards Model for 1D and 2D Patients Grouping

To validate the significance of our findings (in terms of the estimated Wald p-values) we bootstrap our samples (from the two cohorts) and estimate 99% confidence intervals for the βᵢ coefficients of the Cox proportional hazards model. Note that the following discussion considers only the case of 1-D grouping. In the case of the 2-D grouping, we would substitute βᵢ with β_{i,j}^{m} in the following discussion. The bootstrap method though is the same in both cases (1-D and 2-D). Extending this technique for validating the ratio method DDgR is also straightforward, so will not be explained here.

We use the non-parametric residuals bootstrap for the proportional hazards model of Loughin (1995) using the boot package in R.

Specifically, the algorithm works as follows sequentially for each gene i:
1. Estimate βᵢ of model:

log hⁱₖ(tₖ|xₖⁱ,βᵢ)=αᵢ(tₖ)+βᵢ·xₖⁱ
by maximizing the likelihood:

$$L ( {β}_{i} ) = {\prod }_{k = 1}^{K} {\{ \frac{exp ( {β}_{i}^{T} {x}_{k}^{i} )}{{\sum }_{j ∈ R ( {t}_{k} )} exp ( {β}_{i}^{T} {x}_{j}^{i} )} \}}^{{e}_{k}} .$$

2. Calculate the independent and identically (Uniform [0,1]) distributed generalized residuals, calculated in Cox and Snell (1968) and Loughin (1995) by the “probability scale data”

uₖ=[1−F₀(t)]^{exp(β}^{ᵢ}^{^{T}}^{x}^{ₖ}^{ⁱ}⁾, for k=1, 2, . . . K
where F₀(t)=P(T≦t|exp(βᵢ^{T}xⁱ)=1) denotes the baseline failure time distribution. Typically, \hat{F}₀(t) (the estimated value of F₀(t)) is a step function with jumps at the observed failure times (estimated automatically in the survival package of the R library), which does not affect the Uniformity of the generalized residuals (Loughin, 1995)
3. Consider the pairs {(u₁, e₁), . . . , (u_{K}, e_{K})} and resample with replacement B pairs of observations (B bootstrap samples) {(u₁^{(b)}, e₁^{(b)}), . . . , (u_{K}^{(b)}, e_{K}^{(b)})}, for b=1, . . . , B (a typical bootstrap step)
4. Calculate the probability scale survival times

tₖ^{(b)}=1−[uₖ^{(b)}]^{1/exp(β}^{ᵢ}^{^{T}}^{x}^{ₖ}^{ⁱ}⁾
and estimate the bootstrap coefficients βᵢ⁽¹⁾, βᵢ⁽²⁾, . . . , βᵢ^{(B)} by numerically maximizing the partial likelihood:

$${L}^{( b )} ( {β}_{i} ) = {\prod }_{k = 1}^{K} {\{ \frac{exp ( {β}_{i}^{T} {x}_{k}^{i} )}{{\sum }_{j ∈ {R}_{( {t}_{k} )}^{( b )}} exp ( {β}_{i}^{T} {x}_{j}^{i} )} \}}^{{e}_{k}^{( b )}} , b = 1 , … , B$$

Based on these coefficients, we estimate and report the Bias-Corrected accelerated (BCa) bootstrap confidence intervals for each βᵢ coefficient that correct the simple quantile intervals of βᵢ for bias and skewness in their distribution (Efron and Tibshirani, 1994). A detailed discussion (theory and applications) on BCa intervals is given in Efron and Tibshirani (1994). Here the 99% BCa were estimated by the boot package in the R library. Bootstrap test p-values based on quantile method gave similar results using the Wald test.

### 5. Incorporation of Other Survival Models in our 1 D, 2D and Ratio Methods and a Procedure for Model Selection

The most crucial assumption of the Cox proportional hazards survival model is the one concerning the effect of the parameters to the hazard ratio. Specifically, consider two patients k₁ and k₂ modelled by the Cox proportional hazards model

log hⁱₖ(tₖ|xₖⁱ,βᵢ)=αᵢ(tₖ)+βᵢ·xₖⁱ

The hazard log-difference of these two groups must be:

log hⁱₖ_{₁}(tₖ_{₁}|xₖ_{₁}ⁱ, βᵢ)−log hₖ_{₂}ⁱ(tₖ_{₂}|xₖ_{₂}ⁱ, βᵢ)=αᵢ(tₖ_{₁})+βᵢ·xₖ_{₁}ⁱ−(αᵢ(tₖ_{₂})+βᵢxₖ_{₂}ⁱ)=βᵢxₖ_{₁}ⁱ−βᵢxₖ_{₂}ⁱ

which is independent of time t. We call this assumption the proportional hazards assumption of the Cox model. Under these circumstances it is desirable to determine whether the Cox regression model adequately fits the data or, in other words, whether the proportional hazards assumption holds. Tests and graphical diagnostics for proportional hazards may be based on the estimation of the scaled Schoenfeld residuals (rₖ) (Schoenfeld, 1982), which for non-censored patients are estimated as:

$${r}_{i} = {x}_{k}^{i} - {\sum }_{k = 1}^{j ∈ R ( {t}_{k} )} {β}_{i} {x}_{k}^{i}$$

Grambsch and Therneau (1994) developed the respective test statistic that has the form:

$${Test}_{i} = \frac{{\{ \sum ( {g}_{i} - \overline{g} ) {r}_{i} \}}^{2}}{t \times {I}_{i} \times \sum {( {g}_{i} - \overline{g} )}^{2}}$$

where rᵢ are the scaled Schoenfeld residuals for probe i, gᵢ is the time scale, g̅ is the average time scale, and Iᵢ is the information matrix elements for probe i. t is the observed vector of survival times and multiplying it by the Iᵢ matrix gives us a single number (i.e. a 1×1 matrix). This test follows a χ² distribution with one degree of freedom and can be interpreted as a measure of significance for the correlation between the covariate specific residuals and the survival times (if significant correlation exists the proportionality assumption is rejected; see Thompson et al., 2003). Large values of the test (or small p-values) are an indication of non-proportionality in the hazards.

In the survival package in the R library, the proportional hazards test can be done more conveniently with the cox.zph function, which checks the proportional-hazards assumption by correlating the corresponding set of scaled Schoenfeld residuals with a suitable transformation of time for each covariate xⁱ (for more information refer to the survival package in the R library).

The embodiments described below incorporate a test for the proportional hazards assumption applied to the results of the 1 D-, 2D- and ratio-patient grouping methods. When the assumption holds, we can rely on the Cox model and make inferences based on the results of our 1 D/2D/ratio methods. However, when the assumption is not satisfied, we need to think of a proper approach to analyze the data. Note however, that preliminary analysis of our data showed that non-proportionality holds for approximately 1-1.5% of the probes/probe pairs.

Survival Model Misspecification

At this paragraph we wish to discuss a possible reason of the proportionality failure before we describe possible remedies of the problem. Schemper (1992) and Therneau and Grambsch (2000) suggest that certain model specification errors can lead to false positive results of the test. Such specification errors can be simply the omission of an important covariate of the model (either a single covariate or an interaction) or an incorrect functional form of the model. The latter implies that if a parametric model is more appropriate than Cox proportional model for the data, using Cox can lead to a misleading significant test result. In addition, we should take into account the case where proportional hazards assumption does not hold due to the data properties which requires the use of a model that does not make this assumption.

### 6. A Second Embodiment of the Invention

To solve the problem with respect to model misspecification, a second embodiment of the invention uses the 4 different parametric survival models in the top lines of Table 1, along with any one of the 1 D-, 2D- and ratio-methods. Note that these 4 models assume proportional hazards. Parametric survival models are constructed by choosing a specific probability distribution for the survival function. The choice of survival distribution expresses some particular information about the relation of time and any exogenous variables to survival. It is natural to choose a statistical distribution which has non-negative support since survival times are non-negative.

Here we describe the second embodiment in detail with reference to FIG. 3:
1. First we partition the patients of a cohort into groups using any one of the 1 D-, 2D- or ratio-methods (step 11 of FIG. 3), and obtain the corresponding Cox proportional hazards model. We estimate the p-value of the β coefficient of the Cox proportional hazards model as before.
2. Subsequently, we use the cox.zph function of the R library to evaluate whether the assumption of proportional hazards holds. The function produces a p-value, which when it is below a significance level (typically 5%) indicates that the proportionality assumption is not satisfied (step 12 of FIG. 3). If the results indicate that the assumption is met then the method can optionally terminate there, or alternatively (and particularly if we suspect that one of the other parametric models should be more appropriate) we can ignore the results of the Cox model and proceed to step 3. If the result of the text indicates the proportionality assumption is not satisfied, jump to step 15 of FIG. 3 which is explained in the next section of this document.
3. Next (in step 13 of FIG. 3) successively fit each of the four parametric models listed in Table 1 to the same dataset, using the survreg function in the R-library, using the same one of the 1 D-, or 2D- or ratio-methods, to estimate the p-value of the β coefficient in the parametric-type survival models of the form:

tₖ=αᵢ(tₖ)+βᵢxₖⁱ
where t is distributed each time as indicated in the corresponding row of Table 1. The linear model we use to find significant genes is always of the form log hⁱₖ(tₖ|xₖⁱ, βᵢ)=αᵢ(tₖ)+βᵢ·xₖⁱ, estimated with methods depending on the distribution of t.

For the estimation of β one needs to maximize the appropriate likelihood ƒ(t|θ) of each model, where θ denotes a vector of parameters. Notice that this step is similar to what we described in step 1, but requires the use of a parametric model instead of Cox's.
4. Estimate the Bayesian Information Criterion (BIC) to check which model best fits the data (step 14 of FIG. 3). BIC is estimated by:

BIC=−2*log L+p×log(K)
where L denotes the maximized value of the likelihood function of the estimated model, p is the number of parameters of the model and K is the number of observations (patients). Alternatively BIC can be estimated by the step function in the R library. Note that BIC can compare only the parametric models with each other because all of them use as dependent variable the survival times. On the other hand, the Cox model uses ranked survival times and thus it is not straightforwardly comparable to the parametric alternatives.

The Non-Proportional Hazards Case

We will now discuss how the second embodiment deals with the case where proportionality fails due to omission of model parameters or simply because of the data properties (the hazards are not proportional).

Two possible solutions exist: first, these two cases may be handled simultaneously by considering the stratified Cox proportional hazards model of Kalbfleisch and Prentice (1980); second, the embodiment may use a parametric model that does not assume proportional hazards (e.g. the lower two models in Table 1) and fit it as described above. The second embodiment first uses the stratified Cox proportional hazards model, checks whether proportionality is obeyed, and then only if not, moves on to considering the parametric methods which do not assume proportional hazards.

As discussed above, the stratified Cox regression model is a modification of the Cox regression model by the stratification of a covariate that does not satisfy the proportional hazards assumption. Covariates that are assumed to satisfy the proportional hazards assumption are included in the model, whereas the predictor being stratified is not included. As discussed above, the embodiment initially assumes that the patients' grouping (as estimated by the 1 D-, 2D- or ratio methods) satisfies the proportional hazards assumption. However, in the cases that this hypothesis is rejected, we assume that there is at least one additional variable that may cause the problem. Our aim is to create strata based on this additional variable and within this strata estimate the effect of our grouping on survival times. As an additional we consider a series of clinical variables such as the histological grade (obtained from SWS analysis of Kuznetsov et al., 2006), the patients' age, the patients' intrinsic molecular signature, the metastasis status and the endocrine status. For a detailed description of these variables see Kuznetsov et al. (2006) and Kuznetsov et al. (2008).

More mathematically, our procedure to solve non-proportionality problem by the stratified no-interaction Cox proportional hazards model (Kalbfleisch and Prentice, 1980; Ata and Sozer, 2007) or/and with a non-proportional hazards parametric approach can be described as follows:
1. Use first the stratified Cox model (step 15 of FIG. 3). Define the model as:

log h_{k,g}ⁱ(tₖ,xₖⁱ)=α_{i,g}(tₖ)+β_{i,g}xₖⁱ, g=1, 2, . . . , G
where g labels G “strata”. The strata are the different categorizations of the stratum variable, which is not implicitly used in the model (only the grouping variable x is used). To this extent, the baseline hazard α_{i,g}(tₖ) is different in each stratum but the hazards ratios are the same and thus the proportionality assumption holds. In this way we obtain estimates for the coefficients β_{i,g} (which indicates the slope in each stratum).
2. To obtain the overall βᵢβ_{i,g} coefficients and consequently the p-value of interest, we need to multiply the likelihood functions of the one or more strata and maximize our results with respect to βᵢ as before.
3. Repeat steps 1-2 for each of the additional variables used to define the strata (for example, we can take g=2 (user defined) and create strata with variable “tumor grade” or another variable, e.g. “tumor subtype”), and run the Cox proportional hazards test each time to check whether the respective proportionality assumption is satisfied (step 16 of FIG. 3).
4. If the assumption is not satisfied, fit each of the non-proportional parametric models listed in Table 1 by survreg function in the R library and, using our 1D or 2D or ratio method, estimate the p-value of the β coefficient in the parametric-type survival models of the form

tₖ=αᵢ(tₖ)+βᵢxₖⁱ
where t is distributed each time as indicated in Table 1 (step 17 of FIG. 3). Then, estimate the Bayesian Information Criterion (BIC) to check which model best fits the data (step 18 of FIG. 3).

### 7. Four Detailed Examples of the Second Embodiment of the Invention

We now list three detailed examples of algorithms which implement the second embodiment of the invention. All three of these algorithms have the general structure illustrated in FIG. 3.

7.1 Using 1-D Data-Driven Patient Grouping
1. For each gene i, compute the 10th quantile (q₁₀ⁱ) and the 90th quantile (q₉₀ⁱ) of the distribution of the K signal intensity values (i.e. the expression levels of the K patients). Within (q₁₀ⁱ, q₉₀ⁱ), we search for the value that most successfully discriminates the two unknown genetic classes.
2. Form the candidate cut-offs vector of dimension 1×Q, wⁱ=yᵢ^{w}, where yᵢ^{w} is the log-transformed intensities within (q₁₀ⁱ, q₉₀ⁱ) and Q is the number of elements in wⁱ. Each element of the wⁱ is a trial cut-off value. For i=1 and cⁱ=w_{z}ⁱ, z=1, . . . , Q use

$${x}_{k}^{i} = \{ \begin{matrix}1 ( high \text{-} risk ) & if {y}_{i , k} > {c}^{i} \\ 0 ( low \text{-} risk ) & if {y}_{i , k} \leq {c}^{i}\end{matrix}$$

to separate the K subjects with cⁱ.
3. Evaluate the prognostic significance of gene i by reporting the p-value of the estimated βᵢ from Cox proportional hazards model and test the proportional hazards assumption using Grambsch and Therneau (1994) test that uses the scaled Schoenfeld residuals (Schoenfeld, 1982):

$${r}_{i} = {x}_{k}^{i} - {\sum }_{k = 1}^{j ∈ R ( {t}_{k} )} {β}_{i} {x}_{k}^{i}$$

4. Fit the parametric proportional hazards models of the form:

tₖ=αᵢ(tₖ÷βᵢxₖⁱ
and report the p-value of the estimated βᵢ estimated coefficient. Then, estimate the Bayesian Information Criterion (BIC) to check which parametric model best fits the data. BIC is estimated by:

BIC=−2*log L+p×log(K)
where L denotes the maximized value of the likelihood function of the estimated model, p is the number of parameters of the model and K is the number of observations (patients).
5. If the proportional hazards assumption is satisfied one can keep either the Cox proportional hazards model or the best parametric model (in terms of BIC). Else, proceed to the next step.
6. Use the stratified Cox model using a variable to create the strata from a set of clinical variables available in Kuznetsov et al. (2006). Check whether the proportionality assumption is satisfied. If it is not satisfied proceed to the next step.
7. Fit the parametric survival models that do not assume proportional hazards and find the best one in terms of BIC
8. Iterate for all genes i=2, . . . , N
9. Select as prognostic significant the genes with significantly small p-values (p<α=1%).

7.2 Using 2-D Data-Driven Grouping
1. For a given pair i, j with individual cut-offs cⁱ and cⁱ, i≠j, we may classify the patients by seven possible two-group designs.
2. For i=1 and j=2, group the patients by each of the seven designs of FIG. 2 (using individual gene cut-offs) and for each design estimate the seven Wald p-values for β_{i,j} using the Cox proportional hazards model. The best grouping scheme among the five “synergetic” (1-5) and the two “independent” (6-7) models is the one with the smallest p-value β_{i,j}.
3. Test the proportional hazards assumption using Grambsch and Therneau (1994) test that uses the scaled Schoenfeld residuals (Schoenfeld, 1982):

rᵢⱼ=xₖ^{ij}−Σₖ₌₁^{j,∈R(t}^{ₖ}⁾βᵢⱼxₖ^{ij}
4. Fit the parametric proportional hazards models of the form:

tₖ=αᵢⱼ(tₖ)÷βᵢⱼxₖ^{ij}
and report the p-value of the estimated β_{i,j} estimated coefficient (m denotes the best model as estimated from step 2). Then, estimate the Bayesian Information Criterion (BIC) to check which parametric model best fits the data. BIC is estimated by:

BIC=−2*log L+p×log(K)
where L denotes the maximized value of the likelihood function of the estimated model, p is the number of parameters of the model and K is the number of observations (patients).
5. If the proportional hazards assumption is satisfied one can keep either the Cox proportional hazards model or the best parametric model (in terms of BIC). Else, proceed to the next step.
6. Use the stratified Cox model using a variable to create the strata from a set of clinical variables available in Kuznetsov et al. (2006). Check whether the proportionality assumption is satisfied. If it is not satisfied proceed to the next step.
7. Fit the parametric survival models that do not assume proportional hazards and find the best one in terms of BIC
8. Iterate for all genes i=2, . . . , N−1 and j=i+1, . . . , N [symbol] Select as prognostic significant the genes with significantly small p-values (p<a=1%).

7.3 Using Ratio Data Driven Grouping (the Ratio-Method)
1. Compute the difference of the log-transformed intensities of two selected genes i and j.
2. Compute the 10th quantile (q₁₀ⁱ) and the 90th quantile (q₉₀ⁱ) of the distribution of the K log-difference signal intensity values. Within (q₁₀ⁱ, q₉₀ⁱ), we search for the value that most successfully discriminates the two unknown genetic classes.
3. Form the candidate cut-offs vector of dimension 1×Q, wⁱ=yᵢⱼ^{w}, where yᵢⱼ^{w} the log-differenced intensities y_{i,k}−y_{j,k} within (q₁₀ⁱ, q₉₀ⁱ) and Q is the number of elements in wⁱ. Each element of the wⁱ is a trial cut-off value. For i=1 and cⁱ=w_{z}ⁱ, z=1, . . . , Q use

$${x}_{k}^{ij} = \{ \begin{matrix}1 ( high \text{-} risk ) & if {y}_{i , k} - {y}_{j , k} > {c}^{ij} \\ 0 ( low \text{-} risk ) & if {y}_{i , k} - {y}_{j , k} \leq {c}^{ij}\end{matrix}$$

to separate the K subjects with c^{ij}.
4. Evaluate the prognostic significance of gene i by reporting the p-value of the estimated β_{i,j} from Cox proportional hazards model and test the proportional hazards assumption using Grambsch and Therneau (1994) test that uses the scaled Schoenfeld residuals (Schoenfeld, 1982):

$${r}_{ij} = {x}_{k}^{ij} - {\sum }_{k = 1}^{j ∈ R ( {t}_{k} )} {β}_{ij} {x}_{k}^{ij}$$

1. Fit the parametric proportional hazards models of the form:

tₖ=αᵢⱼ(tₖ)÷βᵢⱼxₖ^{ij}
and report the p-value of the estimated β_{i,j} estimated coefficient. Then, estimate the Bayesian Information Criterion (BIC) to check which parametric model best fits the data. BIC is estimated by:

BIC=−2*log L+p×log(K)
where L denotes the maximized value of the likelihood function of the estimated model, p is the number of parameters of the model and K is the number of observations (patients).
2. If the proportional hazards assumption is satisfied one can keep either the Cox proportional hazards model or the best parametric model (in terms of BIC). Else, proceed to the next step.
3. Use the stratified Cox model using a variable to create the strata from a set of clinical variables available in Kuznetsov et al. (2006). Check whether the proportionality assumption is satisfied. If it is not satisfied proceed to the next step.
4. Fit the parametric survival models that do not assume proportional hazards and find the best one in terms of BIC
5. Iterate for all genes i=2, . . . , N
6. Select as prognostic significant the genes with significantly small p-values (p<a=1%).

### 8. Application and Experimental Results

Breast cancer is most common malignancy among women (van't Veer et al., 2002; Sotiriou et al., 2001). We compare our data-driven grouping for individual genes (DDg) and the data-driven grouping for ratios (DDgR) methods by considering the expression patterns of approximately 30,000 gene transcripts (representing by 44,928 probesets (p.s.) on Affymetrix U133A and U133B arrays) in 315 primary breast tumors (NCBI Gene Expression Omnibus (GEO) data sets GSE4922 and GSE1456). The tumor samples were derived from two independent population-based cohorts: Uppsala (249 samples) and Stockholm (159 samples). For details on patients, clinical information, tumor samples and microarrays see (Ivshina et al., 2006).

Information on patients' disease free survival (DFS) times/events and the expression patterns of gene transcripts on Affymetrix U133A and U133b arrays in all primary breast tumors were obtained from NCBI Gene Expression Omnibus (GEO) (Stockholm data set label is GSE4922; Uppsala data set label is GSE1456). The microarray intensities were normalized (by RMA) and the probe set signal intensities were log-transformed and scaled by adjusting the mean signal to a target value of log500 (Liu et al., 2006).

1D Analysis

The first step of our analysis involves estimating the βᵢ of the Cox Proportional hazards survival model:

log hⁱₖ(tₖ|xₖⁱ,βᵢ)=αᵢ(tₖ)+βᵢ·xₖⁱ

for each cohort, where i=1, . . . , 44928 denotes the number of probesets. To do this, we apply our data-driven grouping for individual genes (DDg) using the survival package in the R library. As described above we are particularly interested in storing the p-value of each βᵢ coefficient, which we consider as a measure of group discrimination. At significance level α=1%, we identified 9930 prognostic significant probesets (6559 prognostic gene signatures) in Stockholm and 9737 in Uppsala (6353 prognostic gene signatures).

FIG. 4 presents the distribution of p-values for the 44928 probesets and the 1% cut-off (red line) below which we declare a probe (and the respective gene) as survival significant. The two lists of significant genes obtained from each cohort were compared and 3375 common probesets identified. These common probesets, whose p-values distribution is presented at FIG. 5, form a more reliable prognostic list since they are observed as significant in two independent cohorts.

To further validate the significance of our findings (in terms of the estimated p-values) we bootstrap the Stockholm and Uppsala samples and estimate 99% Bias Correction acceleration (BCa) confidence intervals for the βᵢ coefficients of the Cox proportional hazards model. We use the non-parametric residuals bootstrap approach described above. By applying this second, independent test we intend to produce a more refined and reliable list of prognostic significant genes. Indeed, the residuals bootstrap method resulted in 1844 common Stockholm-Uppsala probesets, verified by two independent statistical procedures and two independent cohorts. Tables 3-4 present the 10 top-list probesets identified by our 1D algorithm under Cox and the best (in terms of BIC) parametric models in two cohorts.

TABLE 3
Top-level probesets identified by 1D grouping in Stockholm. The p-value
(and the cutoff) of the Cox and the best parametric model is reported along
with the p-value of the test for proportional hazards (PHtest; p-values lower
than 5% is an indication to reject the assumption of proportional hazards).

| | | Cox pvalue | | Parametric | |
|---|---|---|---|---|---|
| AffyID | Symbol | (cut) | PHtest | pvalue(cut) | Model(BIC) |
| A.201903_at | UQCRC1 | 4.2E−06(8.44) | 0.92 | 1.9E−06(8.44) | Exponential(323.58) |
| A.206163_at | MAB21L1 | 5.2E−05(5.38) | 0.71 | 5.0E−05(5.55) | Exponential(324.75) |
| A.202154_x_at | TUBB3 | 2.1E−08(8.62) | 0.78 | 2.8E−09(8.62) | Exponential(316.16) |
| A.213726_x_at | TUBB2C | 5.3E−07(9.63) | 0.31 | 1.3E−07(9.63) | Exponential(321.91) |
| A.213034_at | KIAA0999 | 2.2E−07(7.02) | 0.96 | 4.2E−08(7.02) | Exponential(318.13) |
| B.222989_s_at | UBQLN1 | 2.9E−09(7.66) | 0.75 | 5.2E−10(7.66) | Exponential(307.60) |
| A.203612_at | BYSL | 2.3E−07(6.95) | 0.06 | 3.4E−08(6.95) | Exponential(319.19) |
| B.200075_s_at | GUK1 | 2.7E−06(9.42) | 0.75 | 1.2E−06(9.42) | Exponential(323.93) |
| A.212188_at | KCTD12 | 5.2E−07(7.06) | 0.55 | 1.2E−07(7.06) | Exponential(324.65) |
| 8.200065_s_at | ARF1 | 9.4E−07(10.1) | 0.67 | 2.2E−07(10.9) | Exponential(322.14) |

TABLE 4
Top-level probesets identified by 1D grouping in Uppsala. The p-value
(and the cutoff) of the Cox and the best parametric model is reported along
with the p-value of the test for proportional hazards (PHtest; p-values lower
than 5% is an indication to reject the assumption of proportional hazards).

| | | Cox pvalue | | Parametric | |
|---|---|---|---|---|---|
| AffyID | Symbol | (cut) | PHtest | pvalue(cut) | Model(BIC) |
| A.201903_at | UQCRC1 | 1.4E−08(8.61) | 0.96 | 8.2E−07(8.61) | Gaussian(808.96) |
| A.206163_at | MAB21L1 | 3.9E−09(4.58) | 0.98 | 1.7E−06(4.58) | Gaussian(811.10) |
| A.202154_x_at | TUBB3 | 2.7E−05(8.51) | 0.43 | 1.9E−04(8.51) | Gaussian(820.30) |
| A.213726_x_at | TUBB2C | 3.3E−06(9.63) | 0.26 | 1.5E−04(9.63) | Gaussian(820.09) |
| A.213034_at | KIAA0999 | 4.0E−05(7.09) | 0.62 | 4.4E−04(7.18) | Gaussian(821.80) |
| B.222989_s_at | UBQLN1 | 5.7E−04(7.22) | 0.50 | 5.5E−03(7.06) | Gaussian(825.70) |
| A.203612_at | BYSL | 9.3E−05(6.79) | 0.33 | 2.3E−04(6.79) | Gaussian(820.51) |
| B.200075_s_at | GUK1 | 9.9E−06(9.79) | 0.85 | 6.2E−05(9.70) | Gaussian(818.27) |
| A.212188_at | KCTD12 | 7.0E−05(7.86) | 0.22 | 6.4E−05(7.88) | Gaussian(817.90) |
| B.200065_s_at | ARF1 | 4.6E−05(10.9) | 0.95 | 3.9E−04(11.1) | Gaussian(821.92) |

Notice that in Tables 3-4 none of the probesets rejects the assumptions of the proportionality of the hazards. Particularly, this is true for approximately 99% of the individual cases, where the stratified Cox proportional hazards model and the parametric non-proportional hazards alternatives needed to be evaluated.

2D Analysis

We proceed further by using this reliable list of 1844 probes. By sorting the survival p-values in increasing order we identified the top-level 400 probes (corresponding to 310 unique genes) with which we form all possible 79800 gene pairs. Using these pairs we apply our 2D grouping method in Stockholm and Uppsala cohorts. The 2D grouping has been developed by Motakis et al (2008). The 2D grouping algorithm seems to improve significantly the patients' grouping obtained by individual genes.

At 1% significance level, our analysis revealed 50021 significant probesets in Stockholm and 49986 in Uppsala. To validate mathematically our results and be able to select more reliable gene pairs, we refine our lists, based on three criteria;
Criterion 1: the gene synergy (as indicated by the p-values) is highly significant (we require the synergetic p-value to be significantly lower than the p-values of the individual genes of each pair);
Criterion 2: criterion 1 is satisfied in both cohorts;
Criterion 3: the patients' design (FIG. 2) is the same in the two cohorts.

In several cases criterion 3 fails to be satisfied resulting in exclusion of several highly significant and biologically meaningful pairs. To solve this problem we propose here an extension of our 2D algorithm:
1. Estimate the βᵢ^{z} (z=1, . . . , Q) Wald p-values (the model coefficients for all possible cut-offs included in vector wᵢ) for the two cohorts and sort them in increasing order. Store the design by which each p-value in the sorted list is obtained.
2. In each cohort, keep the best solution (triplet: minimum possible Wald p-value, design and patients grouping) which satisfy criteria 1-3.

This procedure results in 20665 highly significant, reproducible synergetic genes by the extended, design-corrected 2D method (i.e. the method of section 7.2 above) at significance level α=1%. FIG. 6 shows the distribution of these 20665 p-values. To further refine our list we apply the residuals bootstrap method to these 20665 significant probesets. In addition, we use Bonferroni correction to reduce the number of false positives. Bonferroni procedure is known to be a conservative test against false positives/negatives but it is still a reliable measure when the data are characterized by unknown but significant dependence. At such cases False Discovery Rate (FDR; Benjamini and Hochberg, 1995) has been reported to produce unreliable results (Benjamini and Yekutieli, 2001).

In the Stockholm cohort we identified 6562 and in Uppsala 8303 significant gene pairs (by applying both BCa and Bonferroni to the original 20665 reproducible pairs). The distribution of the p-values is plotted at the bottom panel of FIG. 6. Finally, we have found 2414 common, highly significant, BCa and Bonferroni validated prognostic pairs. Tables 5-6 present the 10 top-list probeset pairs identified by our 2D algorithm under Cox and the best (in terms of BIC) parametric models in two cohorts.

Notice that in Tables 5-6 none of the probesets rejects the assumptions of the proportionality of the hazards. Particularly, this is true for approximately 98.5% of the paired cases, where the stratified Cox model and the loglogistic/lognormal models needed to be evaluated.

TABLE 5
Top-level probeset pairs identified by 2D grouping in Stockholm. The p-value
(and the design) of the Cox and the best parametric model is reported along
with the p-value of the test for proportional hazards (PHtest; p-values lower
than 5% is an indication to reject the assumption of proportional hazards).

| AffyID1 | AffyID2 | Cox | | Parametric | |
|---|---|---|---|---|---|
| (Symbol) | (Symbol) | pval(des) | PHtest | pval(cut) | Model(BIC) |
| A.201903_at(UQCRC1) | A.204825_at(MELK) | 2.2E−08(2) | 0.63 | 6.1E−09(2) | Exponential(314.90) |
| A.208074_s_at(AP2S1) | A.209642_at(BUB1) | 5.8E−11(2) | 0.39 | 5.3E−12(2) | Exponential(295.84) |
| A.213476_x_at(TUBB3) | A.218883_s_at(MLF1IP) | 1.2E−08(2) | 0.15 | 3.0E−09(2) | Exponential(309.69) |
| A.213034_at(KIAA0999) | A.213726_x_at(TUBB2C) | 2.8E−08(3) | 0.42 | 1.4E−08(3) | Exponential(307.32) |
| A.204962_s_at(CENPA) | B.232652_x_at(SCAND1) | 9.9E−10(2) | 0.30 | 1.5E−10(2) | Exponential(309.89) |
| A.203799_at(CD302) | A.209832_s_at(CDT1) | 2.9E−07(5) | 0.07 | 2.5E−07(5) | Exponential(322.91) |
| A.200860_s_at(CNOT1) | A.208074_s_at(AP2S1) | 9.5E−10(2) | 0.77 | 3.8E−10(2) | Exponential(311.37) |
| A.202338_at(TK1) | A.212070_at(GPR56) | 8.5E−08(2) | 0.09 | 2.2E−08(2) | Exponential(308.25) |
| A.202095_s_at(BIRC5) | A.218354_at(TRAPPC2L) | 1.5E−08(2) | 0.52 | 8.9E−09(2) | Exponential(317.10) |
| A.212189_s_at(COG4) | B.225541_at(RLP22L1) | 1.3E−07(4) | 0.53 | 2.6E−08(4) | Exponential(313.86) |

TABLE 6
Top-level probeset pairs identified by 2D grouping in Stockholm. The p-value
(and the design) of the Cox and the best parametric model is reported along
with the p-value of the test for proportional hazards (PHtest; p-values lower
than 5% is an indication to reject the assumption of proportional hazards).

| AffyID1 | AffyID2 | Cox | | Parametric | |
|---|---|---|---|---|---|
| (Symbol) | (Symbol) | pval(des) | PHtest | pval(cut) | Model(BIC) |
| A.201903_at(UQCRC1) | A.204825_at(MELK) | 2.2E−08(2) | 0.79 | 1.8E−07(2) | Gaussian(806.44) |
| A.208074_s_at(AP2S1) | A.209642_at(BUB1) | 5.8E−11(2) | 0.87 | 2.3E−05(2) | Gaussian(816.46) |
| A.213476_x_at(TUBB3) | A.218883_s_at(MLF1IP) | 1.2E−08(2) | 0.96 | 1.9E−06(2) | Gaussian(810.91) |
| A.213034_at(KIAA0999) | A.213726_x_at(TUBB2C) | 2.8E−08(3) | 0.90 | 8.0E−07(3) | Gaussian(809.91) |
| A.204962_s_at(CENPA) | B.232652_x_at(SCAND1) | 9.9E−10(2) | 0.58 | 2.5E−05(2) | Gaussian(815.97) |
| A.203799_at(CD302) | A.209832_s_at(CDT1) | 2.9E−07(5) | 0.29 | 1.3E−06(5) | Gaussian(810.85) |
| A.200860_s_at(CNOT1) | A.208074_s_at(AP251) | 9.5E−10(2) | 0.98 | 8.6E−06(2) | Gaussian(814.46) |
| A.202338_at(TK1) | A.212070_at(GPR56) | 8.5E−08(2) | 0.49 | 3.3E−06(2) | Gaussian(812.13) |
| A.202095_s_at(BIRC5) | A.218354_at(TRAPPC2L) | 1.5E−08(2) | 0.44 | 9.9E−07(2) | Gaussian(810.69) |
| A.212189_s_at(COG4) | B.225541_at(RLP22L1) | 1.3E−07(4) | 0.99 | 2.8E−08(4) | Gaussian(801.54) |

Gene Ratio Analysis

At the final step of our analysis we attempt to compare the results obtained so far by 1D and 2D grouping approaches against our new ratio data-driven grouping method (DDgR). At this point we consider all 20665 significant probe pairs of the 2D DDg step. Notice that each individual gene, included in this list, is highly significant by our 1D data-driven method.

Each pair is transformed to a log ratio (or log-difference) of intensities; i.e. if we denote by I₁ as the vector of raw intensities of Affy1 and I₂ as the vector of raw intensities of Affy2 for two probesets Affy1 and Affy2 that form a pair, then the log-ratio (or log-difference):

$$log \frac{{I}_{1}}{{I}_{2}} = log {I}_{1} - log {I}_{2}$$

forms the ratio of interest. In this way we form a large sample of 20665 ratios of intensities composed of well-characterized, survival significant genes and gene pairs. By using the DDgR approach, we estimate the survival p-values of βᵢ coefficients, which we compare to our previous results. Tables 7-8 give the 10 top-level probes (and gene symbols) identified by the DDgR and their respective survival p-values in Stockholm and Uppsala cohorts.

TABLE 7
Affy Ids (gene names; symbols) and survival p-values of 10 top-level genes
by DDgR method in Stockholm. The p-value (and the cutoff) of the Cox and the
best parametric model is reported along with the p-value of the test for proportional
hazards (PHtest; p-values lower than 5% is an indication to reject the assumption of
proportional hazards).

| | | Cox | | Parametric | |
|---|---|---|---|---|---|
| Affy ID1 (Symbol) | Affy ID2 (Symbol) | pvalue (cut) | PHtest | pvalue(cut) | Model(BIC) |
| A.212189_s_at(COG4) | A.213034_at(KIAA0999) | 1.0E−10(−0.02) | 0.72 | 9.2E−12(−0.02) | Exponential(307.97) |
| A.206163_at(MAB2IL1) | A.208074_s_at(AP2S1) | 1.1E−08(−3.22) | 0.79 | 3.4E−09(−3.21) | Exponential(311.01) |
| A.202154_x_at(TUBB3) | A.213034_at(KIAA0999) | 8.2E−10(1.49) | 0.99 | 2.6E−07(1.07) | Lognormal(307.22) |
| A.208074_s_at(AP2S1) | A.214894_x_at(MACF1) | 6.6E−08(0.60) | 0.24 | 1.3E−08(0.59) | Exponential(319.12) |
| A.202763_at(CASP3) | A.218614_at(C12orf35) | 6.1E−06(−0.09) | 0.50 | 6.8E−06(−0.20) | Lognormal(321.44) |
| A.200075_s_at(GUK1) | A.206163_at(MAB2IL1) | 5.6E−08(3.16) | 0.85 | 4.5E−07(3.09) | Loglogistic(304.73) |
| A.200886_s_at(PGAM1) | A.212526_at(SPG20) | 9.7E−08(2.81) | 0.79 | 1.8E−08(2.80) | Exponential(318.86) |
| A.213892_s_at(APRT) | A.219563_at(C14orf139) | 6.5E−08(1.36) | 0.19 | 1.7E−08(1.35) | Exponential(311.92) |
| A.214077_x_at(MEIS3P1) | A.219395_at(RBM35B) | 9.2E−09(−0.40) | 0.61 | 1.6E−09(−0.40) | Exponential(315.29) |
| A.208968_s_at(CIAPIN1) | A.214077_x_at(MEIS3P1) | 1.1E−07(1.20) | 0.58 | 4.9E−06(0.65) | Lognormal(322.04) |

TABLE 8
Affy Ids (gene names; symbols) and survival p-values of 10 top-level genes
by DDgR method in Uppsala. The p-value (and the cutoff) of the Cox and the
best parametric model is reported along with the p-value of the test for proportional
hazards (PHtest; p-values lower than 5% is an indication to reject the assumption of
proportional hazards).

| | | Cox | | Parametric | |
|---|---|---|---|---|---|
| Affy ID1 (Symbol) | Affy ID2 (Symbol) | pvalue (cut) | PHtest | pvalue(cut) | Model(BIC) |
| A.212189_s_at(COG4) | A.213034_at(KIAA0999) | 6.4E−08(−0.10) | 0.89 | 8.8E−07(−0.10) | Gaussian(809.01) |
| A.206163_at(MAB2IL1) | A.208074_s_at(AP2S1) | 1.6E−09(−3.90) | 0.99 | 2.8E−07(−3.34) | Gaussian(807.08) |
| A.202154_x_at(TUBB3) | A.213034_at(KIAA0999) | 3.3E−08(1.16) | 0.44 | 1.3E−06(1.16) | Gaussian(810.80) |
| A.208074_s_at(AP2S1) | A.214894_x_at(MACF1) | 1.6E−08(0.41) | 0.18 | 1.9E−07(0.41) | Gaussian(806.67) |
| A.202763_at(CASP3) | A.218614_at(C12orf35) | 2.9E−11(0.03) | 0.84 | 2.4E−08(−0.01) | Gaussian(803.13) |
| A.200075_s_at(GUK1) | A.206163_at(MAB2IL1) | 1.1E−08(3.75) | 0.49 | 2.4E−07(3.65) | Gaussian(806.56) |
| A.200886_s_at(PGAM1) | A.212526_at(SPG20) | 8.1E−09(3.44) | 0.45 | 5.2E−06(3.44) | Gaussian(813.63) |
| A.213892_s_at(APRT) | A.219563_at(C14orf139) | 3.2E−08(1.60) | 0.17 | 4.1E−06(1.60) | Gaussian(813.49) |
| A.214077_x_at(MEIS3P1) | A.219395_at(RBM35B) | 4.0E−07(−1.63) | 0.35 | 1.4E−05(−1.63) | Gaussian(815.89) |

Notice that in Tables 7-8 none of the probesets rejects the assumptions of the proportionality of the hazards. Particularly, this is true for approximately 99% of the paired cases, where the stratified Cox model and the loglogistic/lognormal models needed to be evaluated.

Our new ratio approach improved the classification of 603 out of 20665 (approximately 3%) probe pairs. Each of these survival p-values was lower than both the 2D data-driven and the two 1D data-driven p-values of the respective pair. Note also that the ratio approach improved the patient grouping for 383 out of 400 individual probes (approximately 96%) that formed our gene pairs and consequently our gene ratios in our analysis. FIGS. 7-12 show 3 indicative examples of our comparative analysis across the 2 cohorts. FIGS. 7-10 show two successful implementations of our new DDgR approach while the last two figures indicate the superiority of 1D and 2D method in some cases.

Biological Results and Conclusion

The above preliminary results show that DDgR method and its combination with DDg can be considered as a novel fully automatic and robust methodology for a dual biomedical and patient grouping searching: (1) selection of survival/clinical significant genes (or other available tumor data) providing synergistic effect on patient survival and (2) optimal grouping of the patients onto poorly and good disease outcome groups. Such tasks are appeared in several biomedical studies.

The embodiments can provide practical interest for identification key genetic genes and their interactive gene pairs related directly to patho-biological mechanisms, prediction of disease outcome and screening novel therapeutic targets.

The embodiments were able to find many hundreds robust and statistically strong confidence genes and gene pairs. Several top-level robust gene markers present on the FIGS. 7-12 and Tables 3-8.

Among identified survival significant genes, some of the genes have been considered as clinically significant genes For example, ARF1 (Aurka, STK6), and MELK are survival significant genes which have been included in the genomic grading classification of breast cancers (Ivshina et al, 2006, Kuznetsov et al, 2008). Some of the survival significant genes of Tables 3-8 are in clinical trials (e.g. Survivin, TYMS, MELK). Importantly, combination of mRNA markers in blood including Survivin and TK1 (Thymidine kinase 1) has been used in the diagnosis of patients with breast cancer (Chen et al, 2006). It was also shown that patients' clinic-pathological characteristics tumor size (p=0.006), histologic grade (p=0.012), lymph node metastasis (p=0.001) and TNM stage (p=0.006) significantly correlated with the positive detection rate of these cancer markers. We suggest that not only Survivin and TK1 but other cancer-prognostic multi-markers of Tables 3-8 and could be also used in their combination to detect circulating tumor cells (CTCs) in the circulation of breast cancer patients with considerably high sensitivity and specificity.

Thus, our method can provide practical interest for identification key genetic genes and their interactive gene pairs and composed survival significant genes (SSGs) and their products (mRNAs, proteins, peptides) related directly to pathobiological mechanisms, prediction of disease outcome and screening novel therapeutic targets.

In particular, spartin (SPG20) gene (which is involved in the intracellular trafficking of EGFR and that impaired endocytosis may underlie the pathogenesis of Troyer syndrome) and gene PGAM1 (Phosphoglycerate mutase 1, involved in glycolise pathway) are strongly predicted by the DDgR as the new breast cancer survival synergetic genes pairs. In the literature, the both genes have not been associated with breast cancer and cancer survival. However, our additional analysis of expression PGAM1 based on longSAGE tag (cgap.nci.nih.gov/SAGE) DB demonstrates that this gene is strongly over-expressed in embryonic stem cells, and several cancers, including breast cancer cell line.

DDg and DDgR the both predict that synergic TUBB3-KIAA0999 gene pair. TUBB3 (Tubulin 3) is the major constituent of microtubules. It binds two moles of GTP, one at an exchangeable site on the beta chain and one at a non-exchangeable site on the alpha-chain. This gene is predicted to be survival significant pairing with unknown gene KIAA0999. We found that ChIP-PET experiments show over-expression TUBB3 in ER-positive breast cancer cell line MCF7 cells and in the human ESC hES3 cells. Recently, KIAA099 was included in the list of “candidate of breast cancer genes”, which have been subjected to mutational selection during tumorgenesis (Sjoblom et al, 2006). However, survival significant of this hypothetical gene was not discussed.

We conclude that the embodiments provide a novel approach to identify small gene signatures providing statistically reliable, biological important and clinical significant molecular markers.

TABLE 9
PGAM1 gene top-level expression in ESC and many cancers. SAGE Tag:
GGTCCAGTGT

| | Total Tags | | Tags per |
|---|---|---|---|
| Library | in Library | Tag Counts | 200,000 |
| SAGE_Retina_macula_normal_B_HMAC2 | 102417 | 200 | 390 |
| SAGE_Ovary_normal_CS_HOSE_4 | 47728 | 90 | 377 |
| SAGE_Embryonic_stem_cell_H13_normal_p22_CL_SHE15 | 221101 | 381 | 344 |
| SAGE_Colon_carcinoma_CL_Hct116_p53_knockout_Anoxia | 79053 | 124 | 313 |
| SAGE_Embryonic_stem_cell_HES3_normal_p16_CL_SHE10 | 205353 | 321 | 312 |
| SAGE_Retina_Peripheral_normal_B_2 | 105312 | 160 | 303 |
| SAGE_Vein_normal_B_hs0237 | 6135688 | 8598 | 280 |
| SAGE_Embryonic_stem_cell_HES4_normal_p36_CL_SHE11 | 209232 | 292 | 279 |
| SAGE_Testis_Embryonal_Carcinoma_CL_hs0213 | 5935490 | 8307 | 279 |
| SAGE_Embryonic_stem_cell_H14_normal_p22_CL_SHE14 | 212170 | 273 | 257 |
| SAGE_Embryonic_stem_cell_H9_normal_p38_CL_SHES1 | 151735 | 191 | 251 |
| SAGE_Retina_Macula_normal_B_4Mac | 101417 | 126 | 248 |
| SAGE_Ovary_endometriosis_CL_E12 | 76097 | 93 | 244 |
| SAGE_Breast_carcinoma_CL_MDA435C | 47270 | 56 | 236 |
| SAGE_Colon_carcinoma_CL_Hct116_wildtype_p53_Anoxia | 79015 | 93 | 235 |
| SAGE_Colon_carcinoma_CL_Hct116_p53_knockout_Normal_Oxygen | 79284 | 91 | 229 |
| SAGE_Brain_glioblastoma_control_CL_H247 | 60428 | 68 | 225 |
| SAGE_Ovary_normal_CL_IOSE29EC-11 | 47159 | 53 | 224 |
| SAGE_Testis_Embryonal_Carcinoma_CL_hs0212 | 6370161 | 7124 | 223 |
| SAGE_Embryonic_stem_cell_H1_normal_p31_CL_SHE17 | 276203 | 293 | 212 |
| SAGE_Brain_astrocytoma_grade_II_B_H501 | 128309 | 133 | 207 |
| SAGE_Kidney_embryonic_CL_293 + beta-catenin | 23519 | 24 | 204 |
| SAGE_Uterus_endometrium_normal_CS_DI1 | 21991 | 22 | 200 |
| SAGE_Embryonic_stem_cell_H7_normal_p33_CL_SHE13 | 272465 | 271 | 198 |
| SAGE_Retina_Peripheral_normal_B_1 | 59661 | 59 | 197 |
| SAGE_Ovary_carcinoma_CL_A2780 | 21369 | 21 | 196 |

http://cgap.nci.nih.gov/SAGE/FreqsOfTag?ORG=Hs&METHOD=SS10,LS10&FORMAT=html&TAG=GGTCCAGTGT

The DDg method (but not DDgR) predicts strong clinical significance of genes H2AFZ and RBM35B and its pair H2AFZ-RBM35B. Expression H2AFZ in breast cancer cells was increased and the prognostic power of these biomarkers demonstrated in clinical data (Hua at al., 2008). Gene RBM35B is involved in RNA binding; however, biological function and clinical significance of this gene has been not unknown.

RBM35B forms also the survival significant gene pair with gene MEIS3P1. MEIS3P1 is the homo sapiens Meis homeobox 3 pseudogene 1 which also might be classified as non-coding RNA gene. This gene appears to be a retrotransposed pseudogene based on its lack of exons compared to other family members, one of which is found on chromosome 19 (MEIS3). The MESI3P1 pseudogene lacks three exons compared to MESI3. However, both genes encode proteins of similar size and sequence and contain the same homeodomain, which is a one-of-a-kind DNA binding domain involved in the transcriptional regulation of key eukaryotic developmental processes. MESI3P1 could activate the cAMP-response element (CRE) pathway (Linjie Tian et al, 2007). MEI3P1 has DDgR partner CIAPIN1. CIAPIN1 is a cytokine-induced inhibitor of apoptosis with no relation to apoptosis regulatory molecules of the BCL2 (MIM 151430) or CASP (see MIM 147678) families. Expression of CIAPIN1 is dependent on growth factor stimulation (Shibayama et al., 2004). CIAPIN1, a newly identified apoptosis-related molecule, was found to be down-regulated in several human cancers as compared to the matched adjacent non-neoplastic tissues. It was found that CIAPIN1 is a suppressor of gastric cancer cell proliferation. Due to strong survival significance, we suggest that CIAPIN1 might play an important role in the development of human breast cancer.

Thus, the list of selected genes demonstrates that our survival significance analysis via microarrays can be a powerful technique in elucidating the functions of many novel genes in normal and cancerous tissues. However, many of survival significant and synergetic genes pairs are poorly studied in context of prediction of biological functions and clinical prognostic significance. Our GO network analysis shows that more than 60% gene of top SSSG (Tables 3-8) are not included in the known gene interaction networks (data not presented). These findings strongly suggest that our methodology able to discovery many new clinically important markers and promising molecular targets for drug development and validation.

Among identified survival significant genes, some of the genes have been considered as a clinically significant genes, some of these genes are in clinical trials (e.g. survivin, TYMS, MELK), but the most of identified genes and synergetic genes pairs are novel in context of prediction of biological essentiality and clinical prognostic significance for specific (cancer) diseases.

Our final step involves determining the patients' composite group based on the final list of significant genes and gene pairs identified by our 1D, 2D and DDgR grouping algorithms. In other words, we combine the information from all significant synergetic genes and gene pairs of Tables 3-8 into a single final grouping scheme and then we test whether our algorithm was able to identify two biologically distinct patients' groups.

Our final list of significant findings includes multiple entries of the same genes (e.g. AP2S1 appears at least once in all grouping methods). We assumed that redundancy implies highly correlated groups, which we would like to avoid (e.g. all groupings based on AP2S1 tend to be correlated). To deal with this problem, for each probe set i we sort in ascending order (from the lowest to the highest) the 2D and DDgR Wald P values pᵢⱼ it generates with other probe sets j, j=1, . . . , J and keep the i, j that produces the lowest pᵢⱼ. Subsequently, we do not reconsider i and j either as members of a different pair or as individual entities. Next, we enrich our list with all 1D significant probe sets that do not form any significant pair. We resulted in 17 top-level, representative significant pairs and 4 significant probe sets. These are shown in Table 10 below.

TABLE 10
Integrated list of survival significant genes

| | | Grouping |
|---|---|---|
| AffyID1 | AffyID2 | method |
| A.213476_x_at(TUBB3) | A.218883_s_at(MLF1IP) | 2D |
| A.213034_at(KIAA0999) | A.213726_x_at(TUBB2C) | 2D |
| A.201903_at(UQCRC1) | A.204825_at(MELK) | 2D |
| A.204962_s_at(CENPA) | B.232652_x_at(SCAND1) | 2D |
| A.203799_at(CD302) | A.209832_s_at(CDT1) | 2D |
| A.200860_s_at(CNOT1) | A.208074_s_at(AP2S1) | 2D |
| A.202338_at(TK1) | A.212070_at(GPR56) | 2D |
| A.202095_s_at(BIRC5) | A.218354_at(TRAPPC2L) | 2D |
| A.212189_s_at(COG4) | B.225541_at(RPL22L1) | 2D |
| A.200853_at(H2AFZ) | A.219395_at(RBM35B) | 2D |
| A.214077_x_at(MEIS3P1) | A.219395_at(RBM35B) | DDgR |
| A.202763_at(CASP3) | A.218614_at(C12orf35) | DDgR |
| A.208074_s_at(AP2S1) | A.214894_x_at(MACF1) | DDgR |
| A.200886_s_at(PGAM1) | A.212526_at(SPG20) | DDgR |
| A.200075_s_at(GUK1) | A.206163_at(MAB21L1) | DDgR |
| A.208968_s_at(CIAPIN1) | A.214077_x_at(MEIS3P1) | DDgR |
| A.213892_s_at(APRT) | A.219563_at(C14orf139) | DDgR |
| B.222989_s_at(UBQLN1) | — | 1D |
| A.203612_at(BYSL) | — | 1D |
| A.212188_at(KCTD12) | — | 1D |
| B.200065_s_at(ARF1) | — | 1D |

Table 11 indicates the SEQ ID NO. and the corresponding gene and GenBank reference in the sequence listing.

Where more than one transcript variant exists, the invention may be practiced with any one of the transcript variants, any of several of the transcript variants or all of the transcript variants.

TABLE 11
SEQ ID NOs and corresponding gene

| SEQ ID NO: | Gene | GenBank Reterence |
|---|---|---|
| 1 | TUBB3 | NM_006086.2 |
| 2 | KIA0999 (SIK3) | NM_025164.3 |
| 3 | SPG20 transcript variant 1 | NM_015087.4 |
| 4 | SPG20 transcript variant 2 | NM_001142296.1 |
| 5 | SPG20 transcript variant 3 | NM_01142295.1 |
| 6 | SPG20 var 4 | NM_001142294.1 |
| 7 | PGAM1 | NM_002629.2 |
| 8 | H2AFZ | NM_002106.3 |
| 9 | RBM35B (ESRP2) | NM_024939.2 |
| 10 | UQCRC1 | NM_003365.2 |
| 11 | TUBB2C | NM_006088.5 |
| 12 | MAB21L1 | NM_005584.3 |
| 13 | UBQLN1 var 1 | NM_013438.4 |
| 14 | UBQLN1 var 2 | NM_053067.2 |
| 15 | BYSL | NM_004053.3 |
| 16 | GUK1 var 1 | NM_001159390.1 |
| 17 | GUK1 var 2 | NM_000858.5 |
| 18 | GUK1 var 3 | NM_001159391.1 |
| 19 | KCTD12 | NM_138444.3 |
| 20 | ARF1 transcript variant 1 | NM_001024227.1 |
| 21 | ARF1 transcript variant 2 | NM_001024228.1 |
| 22 | ARF1 transcript variant 3 | NM_001024226.1 |
| 23 | ARF1 transcript variant 4 | NM_001658.3 |
| 24 | BUB1 | NM_004336.3 |
| 25 | MELK | NM_014791.2 |
| 26 | AP2S1 transcript variant AP17 | NM_004069.3 |
| 27 | AP2S1 transcript variant | NM_021575.2 |
| | AP17delta | |
| 28 | MLF1IP | NM_024629.3 |
| 29 | CENPA transcript variant 1 | NM_001809.3 |
| 30 | CENPA transcript variant 2 | NM_001042426.1 |
| 31 | SCAND1 transcript variant 1 | NM_016558.2 |
| 32 | SCAND1 transcript var 2 | NM_033630.1 |
| 33 | CD302 | NM_014880.4 |
| 34 | CDT1 | NM_030928.3 |
| 35 | CNOT1 transcript var 1 | NM_016284.3 |
| 36 | CNOT1 transcript var 2 | NM_206999.1 |
| 37 | TK1 | NM_003258.4 |
| 38 | GPR56 transcript variant 1 | NM_005682.5 |
| 39 | GPR56 transcript variant 2 | NM_201524.2 |
| 40 | GPR56 transcript variant 3 | NM_201525.2 |
| 41 | GPR56 transcript variant 4 | NM_001145771.1 |
| 42 | GPR56 transcript variant 5 | NM_00145770.1 |
| 43 | GPR56 transcript variant 6 | NM_001145772.1 |
| 44 | GPR56 transcript variant 7 | NM_001145774.1 |
| 45 | GPR56 transcript variant 8 | NM_001145773.1 |
| 46 | BIRC5 transcript variant 1 | NM_001168.2 |
| 47 | BIRC transcript variant 2 | NM_001012270.1 |
| 48 | BIRC5 transcript variant 3 | NM_001012271.1 |
| 49 | TRAPPC2L | NM_016209.3 |
| 50 | COG4 | NM_015386.2 |
| 51 | RPL22L1 | NM_001099645.1 |
| 52 | MACF1 transcript variant 1 | NM_012090.3 |
| 53 | MACF1 transcript variant 2 | NM_033044.2 |
| 54 | CASP3 transcript variant alpha | NM_004346.3 |
| 55 | CASP3 transcript variant beta | NM_032991.2 |
| 56 | C12orf35 | NM_018169.3 |
| 57 | APRT transcript variant 1 | NM_000485.2 |
| 58 | APRT transcript variant 2 | NM_001030018.1 |
| 59 | C14orf139 | NR_026779.1 |
| 60 | MEIS3P1 | NR_002211.1 |
| 61 | CIAPIN1 | NM_020313.2 |

### REFERENCES

Ata, N. and Sozer, M. T. (2007). Cox regression models with non-proportional hazards applied to lung cancer survival data, Hacettepe Journal of Mathematics and Statistics, 36, 157-167.

Benjamini, Y. and Hochberg, Y. (1995). Controlling the false discovery rate: a practical and powerful approach to multiple testing, Journal of the Royal Statistical Society, Series B (Methodological) 57 (1): 289-300.

Benjamini, Y. and Yekutieli, D. (2001). The control of the false discovery rate in multiple testing under dependency, Annals of Statistics 29 (4): 1165-1188

Breslow, N. E., Covariance analysis of censored survival data, Biometrics, vol. 30, pp 89-99, 1974.

Broet P., Kuznetsov V. A., J. Bergh J., Liu E. T-B., Miller L. D. (2006) Identifying gene expression changes in breast cancer that distinguish early and late relapse among uncured patients. Bioinformatics, 22, 1477-1485.

Chen C C, Chang T W, Chen F M, Hou M F, Hung S Y, Chong I W, Lee S C, Zhou T H, Lin S R. Combination of multiple mRNA markers (PTTG1, Survivin, UbcH10 and TK1) in the diagnosis of Taiwanese patients with breast cancer by membrane array. Oncology. 2006; 70 (6):438-46. Epub 2007 Jan. 12.

Cox, D. R. (1972). Regression Models and Life Tables (with Discussion). Journal of the Royal Statistical Society, Series B 34:187-220.

Cox R. D. and Oakes, D. (1984). Analysis of Survival Data. London: Chapman and Hall.

Cox, D. R. and Snell, E. J. (1968). A general definition of residuals (with discussion)”, Journal of the Royal Statistical Society, Series B, vol. 30, pp 248-265.

Cui, X. And Churchill, G. A. (2003). Statistical tests for differential expression in cDNA microarray experiments, Genome Biology, 4 (4):210

Efron, B. and Tibshirani, R. J. (1994). An Introduction to the Bootstrap. New York: Chapman and Hall.

Goetz M P, Suman V J, Ingle J N, Nibbe A M, Visscher D W, Reynolds C A, Lingle W L, Erlander M, Ma X J, Sgroi D C, Perez E A, Couch F J. (2006) A two-gene expression ratio of homeobox 13 and interleukin-17B receptor for prediction of recurrence and survival in women receiving adjuvant tamoxifen. Clin Cancer Res.; 12 (7 Pt 1):2080-7.

Grambsch, M. P. and Therneau, M. T. (1994). Proportional Hazards Tests and Diagnostics Based on Weighted Residuals, Biometrika, 81, 515-526.

Hua S, Kallen C B, Dhar R, Baquero M T, Mason C E, Russell B A, Shah P K, Liu J, Khramtsov A, Tretiakova M S, Krausz T N, Olopade O I, Rimm D L, White K P (2008). Genomic analysis of estrogen cascade reveals histone variant H2A.Z associated with breast cancer progression. Mol Syst Biol., 4:188. Epub 2008 Apr. 15.

Ivshina A V, George J, Senko O V., Mow B, Putti T C, Smeds J, Nordgren H, Bergh J, Liu E T-B, Kuznetsov V A, Miller L D (2006). Genetic reclassification of histologic grade delineates new clinical subtypes of breast cancer. Cancer Res. 66, 10292-10301.

Kalbfleisch, J. D. and Prentice, R. L. (1980). The Statistical Analysis of Failure Time Data, New York: John Wiley & Sons, Inc.

Kuznetsov V. A. , Senko O. V., Miller L. D. and Ivshina Anna V. (2006). Statistically Weighted Voting Analysis of Microarrays for Molecular Pattern Selection and Discovery Cancer Genotypes. Intern J of Computer Sciences and Network Security, 6, 73-83.

Kuznetsov, V. A., Motakis E. and Ivshina, A. V. (2008). Low- and High-Agressive Genetic Breast Cancer Subtypes and Significant Survival Gene Signatures, IEEE Congress on Computational Intelligence, Hong-Kong, June 1-6.

LeBrun D, Baetz T, Foster C, Farmer P, Sidhu R, Guo H, Harrison K, Somogyi R, Greller L D, Feilotter H. (2008) Predicting outcome in follicular lymphoma by using interactive gene pairs. Clin Cancer Res. 14 (2):478-87.

Linjie Tian, Pingzhang Wang, 1, Jinh Guo, Xinyu Wang, Weiwei Deng, Chenying Zhang, Dongxu Fu, Xi Gao, Taiping Shi, Dalong Ma. Screening for novel human genes associated with CRE pathway activation with cell microarray’ Genomics, 90, Issue 1, July 2007, 28-34.

Loughin, T. M. (1995). A residual bootstrap for regression parameters in proportional hazards model”, J. of Statistical and Computational Simulations, vol. 52, pp 367-384.

Motakis, E., Ivshina, A. V. and Kuznetsov, V. A. (2008). A data-driven method of identification of essential genes and gene pairs associated with survival time of cancer patients, IEEE Engineering in Medicine and Biology (to appear)

Ruth M. R., Adrian L. Harris, Lionel Tarassenko (2004). Non-linear survival analysis using neural networks, Statistics in Medicine, 23, 825-842

Schemper, M. (1992). Cox analysis of survival data with non-proportional hazard functions, Statistician, 41, 455-465.

Schoenfeld D. (1982). Residuals for the proportional hazards regression model. Biometrika, 69 (1):239-241.

Shibayama H, Takai E, Matsumura I, Kouno M, Morii E, Kitamura Y, Takeda J, Kanakura Y. Identification of a cytokine-induced antiapoptotic molecule anamorsin essential for definitive hematopoiesis. J Exp Med. 2004 Feb. 16; 199 (4):581-92.

Sjoblom T, Jones S, Wood L D, Parsons D W, Lin J, Barber T D, Mandelker D, Leary R J, Ptak J, Silliman N, Szabo S, Buckhaults P, Farrell C, Meeh P, Markowitz S D, Willis J, Dawson D, Willson J K, Gazdar A F, Hartigan J, Wu L, Liu C, Parmigiani G, Park B H, Bachman K E, Papadopoulos N, Vogelstein B, Kinzler K W, Velculescu V E. Science. 2006 Oct. 13; 314 (5797):268-74. Epub 2006 Sep. 7

Sotiriou, T., Perou, C. M., Tibshirani, R. et al. (2001). Gene expression patterns of breast carcinomas distinguish tumor subclasses with clinical implications. Proc Natl Acad Sci USA 98:10869-10874.

Therneau, M. T. and Grambsch, M. P. (2000). Modeling Survival Data: Extending The Cox Model. New York: Springer-Verlag.

Thompson, A. L., Chhikara, S. R. and Conkin, J. (2003). Cox proportional hazards models for modeling the time to onset of decompression sickness in hypobaric environments, NASA/TP-2003-210791, Manuscript.

Tibshirani, R., Hastie, T., Narasimhan, B. and Chu, G. (2002). Diagnosis of multiple cancer types by shrunken centroids of gene expression. PNAS, 99, 6567-6572. van't Veer, L. J., Dai, H., van de Vijver et al. (2002). Gene expression profiling predicts clinical outcome of breast cancer. Nature 415:530-536.

1. A computerized method for identifying one or more genes, or pairs of genes, selected from a set of N genes, which arc statistically associated with prognosis of a potentially fatal medical condition, the method employing test data which, for each subject k of a set of K subjects suffering from the medical condition, indicates (i) a survival time of subject k, and (ii) for each gene i, a corresponding gene expression value y_{i,k} of subject k;
the method comprising:
(i) for each of a plurality of genes or pairs of genes, performing the sub-operations of:
(a) partitioning the K subjects into two subsets using cut-off values, and computationally fitting the corresponding survival times of at least one of the subsets of subjects to a Cox proportional hazard regression model;
(b) determining whether a proportionality assumption of the Cox proportional hazard regression model is satisfied;
(c) if the proportionality assumption is not satisfied, fitting the data-set to at least one additional statistical model which does not satisfy a proportionality assumption; and
(d) obtaining a significance value indicative of prognostic significance of the gene or gene pair;
(ii) identifying one or more of the genes or pairs of genes for which the corresponding significance values have the highest prognostic significance.

2. A method according to claim 1 in which, upon determining in operation (b) that the proportionality assumption is satisfied, the method includes fitting the data-set to one or more additional proportional hazard models, and selecting from among said proportional hazard models according to quality of fit, operation (d) being performed using the proportional hazard model having best quality of fit.

3. A method according to claim 2 in which, in operation (c) the method includes fitting the data-set to a stratified Cox model, determining whether a proportionality hypothesis is satisfied,
if so, operation (d) being performed using the stratified Cox model,
and if not, fitting the data set to at least one additional non-proportional hazard model, and operation (d) being performed using one of said one or more said additional non-proportional hazard models.

4. A computerized method for identifying one or more genes, or pairs of genes, selected from a set of N genes, which are statistically associated with prognosis of a potentially fatal medical condition, the method employing test data which, for each subject k of a set of K subjects suffering from the medical condition, indicates (i) a survival time of subject k, and (ii) for each gene i, a corresponding gene expression value y_{i,k} of subject k;
the method comprising:
(i) for each of a plurality of genes or pairs of genes, performing the sub-operations of:
(a) computationally fitting the test data to a plurality of regression models, each model partitioning the K subjects into two subsets using cut-off values;
(b) identifying which of the regression models best fits the test-data according to a data fit measure, such as the Bayesian Information Criterion; and
(c) using the identified regression model to obtain a significance value indicative of prognostic significance of the gene or gene pair; and
(ii) identifying one or more of the genes or pairs of genes for which the corresponding significance values have the highest prognostic significance.

5. A computerized method for identifying one or more pairs of genes, selected from a set of N genes, which are statistically associated with prognosis of a potentially fatal medical condition, the method employing test data which, for each subject k of a set of K subjects suffering from the medical condition, indicates (i) a survival time of subject k, and (ii) for each gene i, a corresponding gene expression value y_{i,k} of subject k;
the method comprising:
(i) for each of a plurality of pairs of genes (i, j with i≠j), generating a respective plurality of a trial cut-off values of c_{i,j}, and for each of the trial cut-off values:
(a) partitioning the K subjects into two subsets according to whether log(y_{i,k})−log(y_{j,k}) is respectively above or below the trial cut-off value c_{i,j};
(b) computationally fitting the corresponding survival times of at least one of the subset of subjects to a Cox proportional hazard regression model; and
(c) obtaining a significance value indicative of prognostic significance of the gene pair i,j;
(ii) for each of the pairs of genes, identifying the trial cut-off value for which the corresponding significance value indicates the highest prognostic significance for the gene pair i,j; and
(iii) identifying one or more of the pairs of genes i,j for which the corresponding significance values have the highest prognostic significance.

6-9. (canceled)

10. A computerized method according to claim 1, further comprising obtaining information about a first subject in relation to said medical condition, by
(i) for each of the one or more identified genes, or pairs of genes, obtaining corresponding gene expression values of the first subject; and
(ii) obtaining said information the obtained gene expression values and a survival model.

11. A computerized method according to claim 10 in which said information is a prognosis for the first subject who is suffering from the medical condition, a susceptibility of the first subject to the medical condition, a prediction of the recurrence of the medical condition, or a recommended treatment for the medical condition.

12-13. (canceled)

14. A method for obtaining information about a subject in relation to breast cancer, the method comprising:
(a) for at least one pair of genes selected from
(i) TUBB3 and KIAA0999;
(ii) SPG20 and PGAM1; or
(iii) H2AFZ and RBM35B
obtaining corresponding gene expression values of the subject; and
(b) obtaining said information using a statistical model which includes said expression values.

15. A method for obtaining information about a subject in relation to breast cancer, the method comprising:
(a) for at least one pair of genes which is a respective row of the table:

| | |
|---|---|
| A.213476_x_at(TUBB3) | A.218883_s_at(MLF1IP) |
| A.213034_at(KIAA0999) | A.213726_x_at(TUBB2C) |
| A.201903_at(UQCRC1) | A.204825_at(MELK) |
| A 204962_s_at(CENPA) | B.232652_x_at(SCAND1) |
| A.203799_at(CD302) | A.209832_s_at(CDT1) |
| A.200860_s_at(CNOT1) | A.208074_s_at(AP2S1) |
| A.202338_at(TK1) | A.212070_at(GPR56) |
| A.202095_s_at(BIRC5) | A.218354_at(TRAPPC2L) |
| A.212189_s_at(COG4) | B.225541_at(RL22L1) |
| A.200853_at(H2AFZ) | A.219395_at(RBM35B) |
| A.214077_x_at(MEIS3P1) | A.219395_at(RBM35B) |
| A.202763_at(CASP3) | A.218614_at(C12orf35) |
| A.208074_s_at(AP2S1) | A.214894_x_at(MACF1) |
| A.200886_s_at(PGAM1) | A.212526_at(SPG20) |
| A.200075_s_at(GUK1) | A.206163_at(MAB21L1) |
| A.208968_s_at(CIAPIN1) | A.214077_x_at(MEIS3P1) |
| A.213892_s_at(APRT) | A.219563_at(C14orf139), |

and
(b) obtaining said information using a statistical model which includes said expression values.

16. A kit for obtaining data for performing prognosis of breast cancer, the microarray being for measuring the expression value of a set of no more than 100 genes, comprising a pair of genes selected from:
(i) TUBB3 and KIAA0999;
(ii) SPG20 and PGAM1; or
(iii) H2AFZ and RBM35B.

17. A kit for obtaining data for performing prognosis of breast cancer, the kit being for measuring the expression value of a set of no more than 100 genes, the genes comprising at least one pair of genes which is a respective row of the table:

| | |
|---|---|
| A.213476_x_at(TUBB3) | A.218883_s_at(MLF1IP) |
| A.213034_at(KIAA0999) | A.213726_x_at(TUBB2C) |
| A.201903_at(UQCRC1) | A.204825_at(MELK) |
| A.204962_s_at(CENPA) | B.232652_x_at(SCAND1) |
| A.203799_at(CD302) | A.209832_s_at(CDT1) |
| A.200860_s_at(CNOT1) | A.208074_s_at(AP2S1) |
| A.202338_at(TK1) | A.212070_at(GPR56) |
| A.202095_s_at(BIRC5) | A.218354_at(TRAPPC2L) |
| A.212189_s_at(COG4) | B.225541_at(RL22L1) |
| A.200853_at(H2AFZ) | A.219395_at(RBM35B) |
| A.214077_x_at(MEIS3P1) | A.219395_at(RBM35B) |
| A.202763_at(CASP3) | A.218614_at(C12orf35) |
| A.208074_s_at(AP2S1) | A.214894_x_at(MACF1) |
| A.200886_s_at(PGAM1) | A.212526_at(SPG20) |
| A.200075_s_at(GUK1) | A.206163_at(MAB21L1) |
| A.208968_s_at(CIAPIN1) | A.214077_x_at(MEIS3P1) |
| A.213892_s_at(APRT) | A.219563_at(C14orf139) |

18. A kit according to claim 17 in which the genes further include at least one gene selected from:
B.222989_s_at(UBQLN1)
A.203612_at(BYSL)
A.212188_at(KCTD12)
B.200065_s_at(ARF1)

19. A kit according to claim 16 which is an array, or more preferably a microarray.

20. A kit according to any of claim 16 for measuring the expression value of a set of no more than 50 genes.

21. A kit according to any of claim 16 for measuring the expression value of a set of no more than 30 genes.

22. A kit according to any of claim 16 for measuring the expression value of a set of no more than 20 genes.

23. A method according to claim 11, further comprising carrying out said recommended treatment on said first subject.

24. A computerized method according to claim 4, further comprising obtaining information about a first subject in relation to said medical condition, by
(i) for each of the one or more identified genes, or pairs of genes, obtaining corresponding gene expression values of the first subject; and
(ii) obtaining said information the obtained gene expression values and a survival model.

25. A computerized method according to claim 24 in which said information is a prognosis for the first subject who is suffering from the medical condition, a susceptibility of the first subject to the medical condition, a prediction of the recurrence of the medical condition, or a recommended treatment for the medical condition.

26. A method according to claim 25, further comprising carrying out said recommended treatment on said first subject.

27. A computerized method according to claim 5, further comprising obtaining information about a first subject in relation to said medical condition, by
(i) for each of the one or more identified genes, or pairs of genes, obtaining corresponding gene expression values of the first subject; and
(ii) obtaining said information the obtained gene expression values and a survival model.

28. A computerized method according to claim 27 in which said information is a prognosis for the first subject who is suffering from the medical condition, a susceptibility of the first subject to the medical condition, a prediction of the recurrence of the medical condition, or a recommended treatment for the medical condition.

29. A method according to claim 28, further comprising carrying out said recommended treatment on said first subject.
